(19) United States
(12) Patent Application Publication
(10) Pub. No.: US 2026/0354378 A1
(43) Pub. Date: Nov. 12, 2026

(54) OIL-IN-WATER EMULSION FORMULATION, A PROCESS FOR ITS PREPARATION AND ITS USE AS HERBICIDE

(71) Applicant: BASF SE, Ludwigshafen (DE)

(72) Inventors: Claude Taranta, Limburgerhof (DE); Katja Marxer, Limburgerhof (DE); Katharine Klamczynski, Limburgerhof (DE); Bernd Sievernich, Limburgerhof (DE); Benjamin Gicquel, Ecully (FR)

(21) Appl. No.: 19/139,405

(22) PCT Filed: Dec. 18, 2023
(86) PCT No.: PCT/EP2023/086279

§ 371 Date: Jun. 16, 2025

(30) Foreign Application Priority Data
Dec. 21, 2022 (EP) 22215422.1

(51) Int. Cl. A01N 43/10; A01N 25/04; A01N 25/22; A01N 25/30; A01N 43/40; A01P 13/02

(52) U.S. Cl. CPC A01N 43/10; A01N 25/04; A01N 25/22; A01N 25/30; A01N 43/40; A01P 13/02

(57) ABSTRACT

The present invention relates to an oil-in-water emulsion (EW) formulation of a chloroacetamide herbicide and a water-soluble salt of a pyridinecarboxylic acid herbicide, to a process for its preparation and the use or method for controlling undesirable vegetation by applying said formulation.

The present invention relates to an oil-in-water emulsion (EW) formulation of a chloroacetamide herbicide and a water-soluble salt of a pyridinecarboxylic acid herbicide, to a process for its preparation and the use or method for controlling undesirable vegetation by applying said formulation.

### BACKGROUND OF THE INVENTION

The properties of the active compounds and type of formulation may give rise to problems with regard to producibility, stability, applicability and effectiveness of the formulations. For example, failure to meet a set of stability requirements which usually depend on the specific market, application and regulations will certainly lead to failure of its commercialization. There are many reasons for formulation instabilities, such as a) chemical instabilities due to reactions between ingredients (actives and/or inerts, etc.), photo-degradations, and oxidations, etc., b) physical instabilities due to phase separations (Oswald ripening, crystallization, sedimentations, creamings, etc.) and c) environmental factors (temperature, humidity/moisture, etc.).

In today's agrichemical market, it becomes increasingly common to design formulations with multiple active ingredients and their required solvents, safeners, and/or adjuvants, etc., in order to achieve the optimal spectrum, efficacy, and delivery efficiency, which consequently makes formulation stability more and more challenging. Therefore, new formulation technologies that can effectively isolate, hinder, or eliminate, adverse reactions or interactions between incompatible ingredients are often critical for a successful product.

Herbicidal compositions containing multiple herbicides are useful in weed control as they allow combination of actives having complementary modes of action. Combinations offer the benefit of broadening the spectrum of weed control and managing herbicidal resistance which may develop in certain weeds through prolonged herbicide use.

An agricultural formulation containing a chloroacetamide herbicide such as e.g. dimethenamid-P and a water-soluble salt of a pyridinecarboxylic acid herbicide such as e.g. aminopyralid would be very useful for weed control in oil seed rape, for example with a view to providing flexibility of its application from pre-emergence to early post-emergence.

Concentrated oil-in water emulsions of liquid active ingredients or active ingredients dissolved in a solvent are commonly used as agrochemical formulations due to certain advantages provided over other formulation types. Emulsions are water based, contain little or no solvent, allow mixtures of active ingredients to be combined into a single formulation and are compatible with a wide range of packaging material.

Certain agricultural formulations including oil-in water emulsions containing a chloroacetamide herbicide and/or a pyridinecarboxylic acid or a salt thereof have already been described in the prior art.

WO 2009/153247 A2 (equivalent to US 2011/0092367 A1) discloses herbicidal compositions comprising the pyridinecarboxylic acid aminopyralid and a herbicide from the group of lipid biosynthesis inhibitors, inter alia chloroacetanilides. The active compounds as mentioned above can be formulated in various types of formulations including emulsions.

WO 2018/013721 A1 discloses pesticidal microemulsion compositions comprising (a) an oil phase comprising a lipophilic component; (b) an aqueous phase comprising an aqueous solution comprising a salt of a weak-acid, ionic pesticide; and (c) a stabilizing surfactant comprising an oil-soluble or oil-dispersible anionic surfactant, wherein the microemulsion has a microstructure that is non-water-continuous. Further, methods of using these microemulsion compositions are disclosed to prepare pesticidal application mixtures that are oil-in-water (O/W) macroemulsions. Various embodiments also relate to herbicidal compositions comprising an oil phase comprising an acetamide herbicide; and an aqueous phase comprising an aqueous solution comprising an auxin herbicide component comprising an anion of an auxin herbicide and a salt-forming cation.

US 2011/0124590 A1 discloses an oil-in-water emulsion comprising solvent (A), water (B), surfactant (C) and at least 2% by weight of pesticide (D) based on the emulsion, wherein the solvent comprises an aromatic hydrocarbon (a) and a ketone (b). The pesticide (D) may be selected, inter alia, from certain acetamide and pyridine herbicides.

WO 2009/032481 A2 discloses a stable oil-in-water emulsion which comprises: a) a discontinuous oil phase comprising from 1 g/L to 700 g/L of triclopyr butoxyethyl ester; b) a continuous aqueous phase comprising from 100 g/L to 990 g/L of water and from 1 g/L to 300 g/L of a salt of aminopyralid; c) from 1 g/L to 200 g/L of a first polymeric surfactant comprising an ABA block copolymer having a hydrophilic portion of polyethylene oxide (PEG) and a hydrophobic portion of 12-hydroxystearic acid, and from 1 g/L to 200 g/L of a second polymeric surfactant comprising a polyalkylene glycol ether; and d) optionally, other inert formulation ingredients.

WO 2009/120486 A1 discloses an oil-in-water emulsion composition having an oil phase and water phase, the oil-in-water emulsion composition comprising an oil adapted to form oily globules having a mean particle diameter of less than 800 nanometers, at least one agriculturally active compound (inter alia certain amide, chloroacetanilide and pyridine herbicides), at least one non-ionic lipophilic surface-active agent, at least one non-ionic hydrophilic surface-active agent, at least one ionic surface-active agent, at least one polymeric surface-active agent and water.

WO 2012/097149 A1 discloses an oil-in-water emulsion, comprising oily globules that include at least one agriculturally active ingredient, in which the oily globules of the emulsion are coated with a polymeric adsorption layer and have mean particle diameter of less than about 800 nanometers. The polymeric adsorption layer coating the oily globules includes (1) at least one polymeric surface-active agent having an HLB value in the range of about 16 to about 18, and (2) at least one ionic surface-active agent. Agriculturally active ingredients that can be used with the emulsion also include various herbicides, inter alia certain amide, chloroacetanilide and pyridine herbicides.

U.S. Ser. No. 11/116,208 B2 describes a pesticidal microemulsion composition comprising (a) an oil phase comprising a lipophilic component; (b) an aqueous phase comprising an aqueous solution comprising a salt of a weak-acid, ionic pesticide; and (c) a stabilizing surfactant comprising an oil-soluble or oil-dispersible anionic surfactant. The microemulsion composition has a non-water-continuous microemulsion microstructure. The oil phase is dielectricity-modified with at least one dielectricity modifier selected from various compounds. The lipophilic component comprises an acetamide herbicide which may be, inter alia, dimethenamid or dimethenamid-P; and the salt of a weak-acid, ionic pesticide comprises an auxin herbicide and/or a PPO inhibitor, each of the aforementioned herbicide groups being selected from various compounds. The anionic surfactant is selected from various groups. Furthermore, the pesticidal microemulsion composition is thermodynamically stable at a temperature in the range of about −20 °C to about 54 °C for about 16 hours.

However, there are also several disadvantages of such emulsions, namely that they are often complex formulations which require high amounts of surface-active agents for stabilization, are generally very viscous, have a tendency for Oswald ripening of the fine emulsion droplets and separate over time. Therefore, improvements in such emulsion formulations are needed in the agricultural field.

Thus, there is an ongoing need to find additives or certain combination of additives for oil-in-water emulsions that may enhance the biological effectivity of the composition and/or increase its physical and/or chemical stability and/or increase the loading of oil-in-water emulsions with active ingredients and/or adjuvants. There are several advantages associated with these improvements. For instance, increased biological effectivity allows for lower application rates of the active ingredient, which reduces costs and health risks for the user. Higher loading of oil-in-water emulsions reduces the weight of a given packaging unit, thereby facilitating transportation and handling of the canisters containing the oil-in-water emulsions. Furthermore, a better physical and/or chemical stability increases the shelf life of the product, which is of relevance for storage and/or facing difficult climate conditions. Oil-in-water emulsions with higher loading of active ingredients and/or adjuvants suffer from stability problems, such as Oswald ripening, crystallization, sedimentations and creamings. Furthermore, oil-in-water emulsions with higher loading often have a high viscosity, which negatively affects their handling by the applicant or user of such emulsions, for instance the farmer. Individual improvements on the one hand may lead to detrimental effects on the other hand, which need to be balanced. It is also desirable to find ready-mix formulations including different active substances like a chloroacetamide herbicide and a pyridinecarboxylic acid salt, providing farmers with greater flexibility in application timing from pre- to post-emergence treatments and still complying with the maximum dose rates of the individual active substances and/or ensuring crop safety, especially in Brassica crops such as oilseed rape or canola. Thus, adjusting oil-in-water emulsions for their agricultural use is a continuous challenge and give rise to ongoing tasks, which need to be addressed during formulation development.

### SUMMARY OF THE INVENTION

It was therefore an object of the present invention to provide an oil-in-water emulsion (EW) formulation comprising a water-insoluble chloroacetamide herbicide (in particular dimethenamid-P) in combination with a water-soluble salt of a pyridinecarboxylic acid herbicide (in particular aminopyralid) which has a high physical and/or chemical stability, a high loading of the active ingredients and/or adjuvants, has a high biological activity, can be easily handled and applied by the end user and allows more flexibility in application timing from pre- to post-emergence treatments, whilst complying with the maximum dose rates of said herbicides and/or ensuring excellent crop safety, particularly in crops from the genus Brassica (e.g., oilseed rape or canola).

These and further objects are achieved by the oil-in-water emulsion formulation as described below.

Accordingly, in one aspect of the invention, there is provided an oil-in-water emulsion formulation comprising
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water, and
c) a surfactant mixture C comprising at least two nonionic surfactants C.1 and C.2 and at least one anionic surfactant C.3.

Surprisingly, it was found that the use of a specific combination of solvents having different polarity with a surfactant system of non-ionic and anionic surfactants in the oil phase provides stable oil-in-water emulsions which are even stable if high concentrations of a water-insoluble chloroacetamide herbicide (in particular dimethenamid-P) is contained the oil phase along with a water-soluble salt of a pyridinecarboxylic acid herbicide (in particular aminopyralid) in the aqueous phase. Moreover, it was shown that the use of a solvent mixture comprising a non-polar solvent S1 and a solvent S2 having a higher polarity than the non-polar solvent S1 such as, for example, 2,2,4-trimethyl-1,3-pentanediol monoisobutyrate and N,N-dimethyllactamide in the oil-in-water emulsion formulation of this invention provides a significantly better post-emergence weed control compared with the sole use of the non-polar solvent S1, while complying with the maximum dose rates of the individual active substances present in the formulation of this invention and/or ensuring crop safety. This provides a post-emergence weed control option, especially in oilseed rape, thus allowing a more flexible application timing. Further advantages of the oil-in-water emulsion formulation of this invention are described hereinbelow.

The present invention also provides a process for preparing the oil-in-water emulsion formulation as described herein which will be further detailed below.

The present invention further relates to a method for controlling undesirable vegetation comprising applying the oil-in-water emulsion formulation as defined herein to the vegetation or the locus thereof and to the use of the oil-in-water emulsion formulation as defined herein for controlling undesirable vegetation.

All amounts, concentrations, ratios and percentages are by weight unless otherwise indicated. In this regard, “wt. %” and “% by weight” as used herein all relate to weight percentage.

The following definitions apply to terms as used herein.

The articles “a”, “an” and “the” each refer to one or more, unless otherwise indicated.

The term “oil-in-water emulsion formulation”, as used herein, means the undiluted formulation.

The terms “oil-in-water emulsion formulation”, “emulsion” and “formulation”, as used herein, are synonyms.

The terms “plants” and “vegetation”, as used herein, include germinant seeds, emerging seedlings, plants emerging from vegetative propagules, and established vegetation.

The term “locus”, as used herein, means the area in which the undesirable vegetation or crop plants are growing or will grow.

The terms “controlling” and “combating”, as used herein, are synonyms.

The terms “undesirable vegetation”, “harmful plants”, “unwanted plants”, “weeds” and “weed species”, as used herein, are synonyms.

### DETAILED DESCRIPTION OF THE INVENTION

The oil-in-water emulsion formulation according to the invention comprises an oil phase as the discontinuous phase and an aqueous phase as the continuous phase. The oil phase usually forms droplets within the aqueous phase. The average particle size Do of the oil phase droplets in the emulsion is generally in the range of from 0.2 μm to 1.5 μm, preferably 0.4 μm to 1.0 μm. The average particle size D₅₀ values given herein represent the volume median particle size derived from measuring the particle size volume distribution using laser diffraction particle size analysis, for example as determined according to ISO 13320, Particle Size Analysis—Laser Diffraction Methods, Dec. 1, 2009. The notation Dₓ means that X % of the particles (volume distribution) have a diameter value below a specified diameter D. For example, a D₅₀ value of 1 μm means that 50% of the particles (volume distribution) have a diameter of less than 1 μm.

The discontinuous oil phase a) of the oil-in-water emulsion formulation disclosed herein comprises a herbicide A selected from chloroacetamide herbicides and a solvent mixture S comprising a non-polar solvent S1 and a solvent S2 having a higher polarity than the non-polar solvent S1.

The herbicide A is preferably selected from acetochlor, alachlor, allidochlor, amidochlor, butachlor, butenachlor, delachlor, diethatyl, dimethachlor, dimethenamid, dimethenamid-P, ethachlor, ethaprochlor, metazachlor, metolachlor, S-metolachlor, pethoxamid, pretilachlor, propachlor, propisochlor, prynachlor, terbuchlor, thenylchlor, xylachlor, and salts and esters thereof, more preferably from acetochlor, alachlor, allidochlor, butachlor, butenachlor, delachlor, diethatyl, dimethachlor, dimethenamid, dimethenamid-P, metazachlor, metolachlor, S-metolachlor, pethoxamid, pretilachlor, propachlor, propisochlor, prynachlor, thenylchlor, and salts and esters thereof, yet more preferably from acetochlor, alachlor, allidochlor, butachlor, butenachlor, delachlor, diethatyl-ethyl, dimethachlor, dimethenamid, dimethenamid-P, metazachlor, metolachlor, S-metolachlor, pethoxamid, pretilachlor, propachlor, propisochlor, prynachlor, and thenylchlor, still more preferably from acetochlor, alachlor, butachlor, dimethachlor, dimethenamid, dimethenamid-P, metazachlor, metolachlor, S-metolachlor, pethoxamid, and pretilachlor and in particular from acetochlor, dimethachlor, dimethenamid, dimethenamid-P, metazachlor, metolachlor, S-metolachlor, and pethoxamid. Particularly preferably, the herbicide A is selected from dimethenamid, dimethenamid-P or a mixture thereof. Most preferably, the herbicide A is dimethenamid-P.

Dimethenamid (i.e. (RS)-2-chloro-N-(2,4-dimethyl-3-thienyl)-N-(2-methoxy-1-methylethyl)acetamide) and its S-isomer with the common name dimethenamid-P (i.e. (S)-2-chloro-N-(2,4-dimethyl-3-thienyl)-N-(2-methoxy-1-methylethyl)acetamide) are known herbicides that are described in the The Pesticide Manual, Fourteenth Edition, Editor: C. D. S. Tomlin, British Crop Production Council, 2006, entry 268, pages 341-343.

The oil-in-water emulsion formulation according to the invention may comprise the herbicide A (in particular dimethenamid-P) in a concentration of at least 20% by weight, preferably at least 30% by weight, more preferably at least 40% by weight, in each case based on the total weight of the formulation. The oil-in-water emulsion formulation of this invention may comprise the herbicide A (in particular dimethenamid-P) in a concentration of up to 70% by weight, preferably up to 60% by weight, more preferably up to 50% by weight, in each case based on the total weight of the formulation. The oil-in-water emulsion formulation of this invention may comprise the herbicide A (in particular dimethenamid-P) in a concentration of from 10 to 70% by weight, preferably 20 to 60% by weight, more preferably 30 to 60% by weight, most preferably 40 to 50% by weight, in each case based on the total weight of the formulation.

The solvent mixture S contained in the discontinuous oil phase a) of the oil-in-water emulsion formulation of this invention comprises a non-polar solvent S1 and a solvent S2 having a higher polarity than the non-polar solvent S1.

According to the invention, the term “non-polar solvent S1” is understood to include those solvents which are essentially immiscible with water, i.e., any solvent having a solubility in water of 0.1% by weight or less at 21 °C, preferably 0.01% by weight or less at 21 °C, in each case based on the amount of water. Preferred non-polar solvents S1 are also those whose dielectric constant at 25 °C is less than 5, and in particular those whose dielectric constant at 25 °C is less than 3. Suitable examples of the non-polar solvent S1 include aliphatic, branched, straight-chain, cyclic or aromatic hydrocarbons having a variable chain length, degree of branching and molecular weight, paraffinic, naphthenic and aromatic oils and waxes and long-chain esters, alcohols, ketones, ethers, halogenated aliphatic and/or aromatic hydrocarbons and any combination thereof.

In a preferred embodiment, the non-polar solvent S1 is selected from aromatic hydrocarbons. Preferred are aromatic hydrocarbons or their mixtures with an initial boiling point of at least 160 °C, preferably at least 180 °C. Examples of aromatic hydrocarbons are benzene, toluene, o-, m- or p-xylene, naphthalene, biphenyl, o- or m-terphenyl, aromatic hydrocarbons which are mono- or polysubstituted by C₁-C₂₀-alkyl, such as ethylbenzene, dodecylbenzene, tetradecylbenzene, hexadecylbenzene, methylnaphthalene, diisopropylnaphthalene, hexylnaphthalene or decylnaphthalene. Others which are suitable are aromatic hydrocarbon mixtures with an initial boiling point of at least 160 °C. Such compounds are for example commercially available from ExxonMobil or BP under the following trade names: Solvesso® 100, Solvesso® 150, Solvesso® 200, Solvesso® 150ND, Solvesso® 200ND, Aromatic® 150, Aromatic® 200, Hydrosol® A 200, Hydrosol® A 230/270, Caromax® 20, Caromax® 28, Aromat® K 150, Aromat® K 200, Shellsol® A 150, Shellsol® A 100, Fin® FAS-TX 150, Fin® FAS-TX 200. Preferred aromatic hydrocarbons are aromatic hydrocarbon mixtures with an initial boiling point of at least 160 °C, preferably at least 180 °C. Mixtures of the above aromatic hydrocarbons are also possible.

In another preferred embodiment, the polarity of the solvent S2 is measured by the Hansen solubility parameters, a sum of the Hansen parameter for polarity (δₚ) and the Hansen parameter for hydrogen bonding (δₕ) being higher than the sum of the corresponding Hansen parameters of the non-polar solvent S1.

In another preferred embodiment, the Hansen parameter for polarity (δₚ) of the solvent S2 is in the range from 5 to 15 MPa^{0.5}, preferably in the range from 5 to 13 MPa^{0.5}. In another preferred embodiment, the Hansen parameter for hydrogen bonding (δₕ) of the solvent S2 is in the range from 8 to 20 MPa^{0.5}, preferably in the range from 10 to 15 MPa^{0.5}. In another preferred embodiment, the Hansen parameter for polarity (δₚ) of the non-polar solvent S1 is in the range from 0 to 4 MPa^{0.5}, preferably in the range from 0 to 3 MPa^{0.5}. In another preferred embodiment, the Hansen parameter for hydrogen bonding (δₕ) of the non-polar solvent S1 is in the range from 0 to 6 MPa^{0.5}, preferably in the range from 2 to 6 MPa^{0.5}.

In another preferred embodiment, the Hansen parameter for polarity (δₚ) of the solvent S2 is in the range from 5 to 15 MPa^{0.5}, preferably in the range from 5 to 13 MPa^{0.5}, and the Hansen parameter for hydrogen bonding (δₕ) of the solvent S2 is in the range from 8 to 20 MPa^{0.5}, preferably in the range from 10 to 15 MPa^{0.5}. In another preferred embodiment, the Hansen parameter for polarity (δₚ) of the non-polar solvent S1 is in the range from 0 to 4 MPa^{0.5}, preferably in the range from 0 to 3 MPa^{0.5}, and the Hansen parameter for hydrogen bonding (δₕ) of the non-polar solvent S1 is in the range from 0 to 6 MPa^{0.5}, preferably in the range from 2 to 6 MPa^{0.5}.

In another preferred embodiment, the sum of the Hansen parameter for polarity (δₚ) and the Hansen parameter for hydrogen bonding (δₕ) of the solvent S2 is 12 MPa^{0.5} or more, preferably 15 MPa^{0.5} or more. In another preferred embodiment, the sum of the Hansen parameter for polarity (δₚ) and the Hansen parameter for hydrogen bonding (δₕ) of the non-polar solvent S1 is 10 MPa^{0.5} or less, preferably 8 MPa^{0.5} or less.

In another preferred embodiment, the sum of the Hansen parameter for polarity (δₚ) and the Hansen parameter for hydrogen bonding (δₕ) of the solvent S2 is 12 MPa^{0.5} or more, preferably 15 MPa^{0.5} or more, and the sum of the corresponding Hansen parameters of the non-polar solvent S1 is 10 MPa^{0.5} or less, preferably 8 MPa^{0.5} or less.

In another preferred embodiment, the sum of the Hansen parameter for polarity (δₚ) and the Hansen parameter for hydrogen bonding (δₕ) of the solvent S2 is in the range from 12 to 40 MPa^{0.5}, preferably in the range from 12 to 35 MPa^{0.5} and more preferably in the range from 15 to 30 MPa^{0.5}. In another preferred embodiment, the sum of the Hansen parameter for polarity (δₚ) and the Hansen parameter for hydrogen bonding (δₕ) of the non-polar solvent S1 is in the range from 0 to 10 MPa^{0.5}, preferably in the range from 0 to 8 MPa^{0.5}.

In another preferred embodiment, the sum of the Hansen parameter for polarity (δₚ) and the Hansen parameter for hydrogen bonding (δₕ) of the solvent S2 is in the range from 12 to 40 MPa^{0.5}, preferably in the range from 12 to 35 MPa^{0.5} and more preferably in the range from 15 to 30 MPa^{0.5}, and the sum of the corresponding Hansen parameters of the non-polar solvent S1 is in the range from 0 to 10 MPa^{0.5}, preferably in the range from 0 to 8 MPa^{0.5}.

In another preferred embodiment, the sum of the Hansen parameter for polarity (δₚ) and the Hansen parameter for hydrogen bonding (δₕ) of the solvent S2 is in the range from 13 to 20 MPa^{0.5}, and the sum of the corresponding Hansen parameters of the non-polar solvent S1 is in the range from 2 to 8 MPa^{0.5}.

In another preferred embodiment, the sum of the Hansen parameter for polarity (δₚ) and the Hansen parameter for hydrogen bonding (δₕ) of the solvent S2 is in the range from 20 to 30 MPa^{0.5}, and the sum of the corresponding Hansen parameters of the non-polar solvent S1 is in the range from 2 to 8 MPa^{0.5}.

The Hansen solubility parameters of the solvents S1 and S2 used in this invention, i.e., the Hansen parameter for polarity (δₚ) and the Hansen parameter for hydrogen bonding (δₕ) of the solvents S1 and S2, can be obtained from known tables or experimental methods, such as those described in Hansen Solubility Parameters, A User's Handbook, Second Edition, Charles M. Hansen, CRC Press 2007. Alternatively, the Hansen solubility parameters of the solvents S1 and S2 can be calculated by using group contribution methods and quantitative structure property relationships in established software tools like COSMOquick or Hansen Solubility Parameters in Practice (HSPiP).

In a preferred embodiment, the solvent S2 is selected from 2-ethylhexanol, 2,2,4-trimethyl-1,3-pentanediol monoisobutyrate, N,N-dimethyl(C₂-C₂₀)hydroxyalkylamides and any combination thereof, preferably from 2,2,4-trimethyl-1,3-pentanediol monoisobutyrate, N,N-dimethyl(C₂-C₂₀)hydroxyalkylamides or a combination thereof.

2-ethylhexanol and 2,2,4-trimethyl-1,3-pentanediol monoisobutyrate are both commercially available solvents, the latter sold by Dow under the tradename UCAR™ Filmer IBT.

The term “hydroxyalkyl” of the N,N-dimethyl(C₂-C₂₀)hydroxyalkylamides refers to an alkyl group that includes one or more hydroxy substituents such as, for example, 2-hydroxyethyl, 3-hydroxypropyl, 2-hydroxypropyl, and 2,2-dihydroxyethyl. Suitable N,N-dimethyl(C₂-C₂₀)hydroxyalkylamides include N,N-dimethyllactamide (e.g., Agnique® AMD 3L available from BASF SE).

In a more preferred embodiment, the solvent S2 is selected from 2,2,4-trimethyl-1,3-pentanediol monoisobutyrate, N,N-dimethyllactamide or a combination thereof.

In a particularly preferred embodiment, the solvent S2 is 2,2,4-trimethyl-1,3-pentanediol monoisobutyrate.

In another preferred embodiment, the solvent S2 is N,N-dimethyllactamide.

Preferably, the non-polar solvent S1 is selected from aromatic hydrocarbons and the solvent S2 is selected from 2-ethylhexanol, 2,2,4-trimethyl-1,3-pentanediol monoisobutyrate, N,N-dimethyl(C₂-C₂₀)hydroxyalkylamides and any combination thereof.

More preferably, the non-polar solvent S1 is selected from aromatic hydrocarbons and the solvent S2 is selected from 2,2,4-trimethyl-1,3-pentanediol monoisobutyrate, N,N-dimethyllactamide or a combination thereof.

Yet more preferably, the non-polar solvent S1 is selected from aromatic hydrocarbons and the solvent S2 is 2,2,4-trimethyl-1,3-pentanediol monoisobutyrate.

In another preferred embodiment, the non-polar solvent S1 selected from aromatic hydrocarbons and the solvent S2 is N,N-dimethyllactamide.

In another preferred embodiment, the non-polar solvent S1 is selected from aromatic hydrocarbon mixtures with an initial boiling point of at least 160 °C, preferably at least 180 °C, and the solvent S2 is selected from 2,2,4-trimethyl-1,3-pentanediol monoisobutyrate, N,N-dimethyllactamide or a combination thereof.

Yet more preferably, the non-polar solvent S1 is selected from aromatic hydrocarbon mixtures with an initial boiling point of at least 160 °C, preferably at least 180 °C, and the solvent S2 is 2,2,4-trimethyl-1,3-pentanediol monoisobutyrate.

In another preferred embodiment, the non-polar solvent S1 is selected from aromatic hydrocarbon mixtures with an initial boiling point of at least 160 °C, preferably at least 180 °C, and the solvent S2 is N,N-dimethyllactamide.

In another preferred embodiment, the solvent mixture S has a solubility in water of 0.1% by weight or less at 21 °C, preferably 0.01% by weight or less at 21 °C, in each case based on the amount of water.

In yet another preferred embodiment, the solvent mixture S has a flash point of at least 70 °C, preferably at least 100 °C.

The oil-in-water emulsion formulation according to the invention may comprise the solvent mixture S in a concentration of at least 1% by weight, preferably at least 3% by weight, more preferably at least 4% by weight, in each case based on the total weight of the formulation. The oil-in-water emulsion formulation of this invention may comprise the solvent mixture S in a concentration of up to 30% by weight, preferably up to 20% by weight, more preferably up to 10% by weight, in each case based on the total weight of the formulation. The oil-in-water emulsion formulation of this invention may comprise the solvent mixture S in a concentration of from 1 to 30% by weight, preferably 3 to 25% by weight, more preferably 4 to 15% by weight, most preferably 4 to 10% by weight, in each case based on the total weight of the formulation.

The concentration of the non-polar solvent S1 is generally at least 1% by weight, preferably at least 3% by weight, more preferably at least 4% by weight, in each case based on the total weight of the formulation. The concentration of the non-polar solvent S1 is generally up to 30% by weight, preferably up to 20% by weight, more preferably up to 10% by weight, in each case based on the total weight of the formulation. The concentration of the non-polar solvent S1 is generally from 1 to 30% by weight, preferably 3 to 25% by weight, more preferably 4 to 15% by weight, most preferably 4 to 10% by weight, in each case based on the total weight of the formulation.

The concentration of the solvent S2 is generally at least 1% by weight, preferably at least 2.5% by weight, more preferably at least 4% by weight, in each case based on the total weight of the formulation. The concentration of the solvent S2 is generally up to 10% by weight, preferably up to 8% by weight, more preferably up to 7% by weight, in each case based on the total weight of the formulation. The concentration of the solvent S2 is generally from 1 to 10% by weight, preferably 2.5 to 8% by weight, more preferably 4 to 7% by weight, in each case based on the total weight of the formulation.

In a preferred embodiment, the solvent mixture S comprises 1 to 30 wt. %, preferably 3 to 25 wt. %, more preferably 4 to 15 wt. %, most preferably 4 to 10% by weight, of a solvent S1 selected from aromatic hydrocarbons and 1 to 10 wt. %, preferably 2.5 to 8 wt. %, more preferably 4 to 7 wt. % of a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the amounts given in wt. % being each based on the total weight of the formulation.

The continuous oil phase b) of the oil-in-water emulsion formulation disclosed herein comprises a herbicide B which is a water-soluble salt of a pyridinecarboxylic acid herbicide and water.

The herbicide B is preferably selected from a water-soluble salt of aminopyralid, clopyralid, florpyrauxifen, halauxifen and picloram. More preferably, the herbicide B is water-soluble salt of aminopyralid.

Exemplary water-soluble salts of the aforementioned pyridinecarboxylic acid herbicides include, for example, sodium salts, potassium salts, ammonium salts or substituted ammonium salts, in particular mono-, di-, and tri-C₁-C₃-alkylammonium salts such as methyl ammonium, dimethylammonium, triethylammonium, and isopropylammonium, mono-, di- and tri-hydroxy-C₂-C₃-alkylammonium salts such as hydroxyethylammonium, di(hydroxyethyl)ammonium, tri(hydroxyethyl)ammonium, hydroxypropylammonium, di(hydroxypropyl)ammonium and tri(hydroxypropyl)ammonium salts, triisopropanolammonium salts, olamine salts, and diglycolamine salts.

In a preferred embodiment, the water-soluble salt of aminopyralid is selected from aminopyralid-sodium, aminopyralid-potassium, aminopyralid-choline salt, aminopyralid-ammonium, aminopyralid-methylammonium, aminopyralid-dimethylammonium, aminopyralid-isopropylammonium, aminopyralid-hydroxy ethylammonium, aminopyralid-di(hydroxyethyl)ammonium, aminopyralid-tri(hydroxyethyl)ammonium, aminopyralid-hydroxypropylammonium, aminopyralid-di(hydroxypropyl)ammonium, aminopyralid-tri(hydroxypropyl)ammonium, aminopyralid-triisopropanolammonium, aminopyralid-diglycolamine salt, aminopyralid-olamine salt, aminopyralid-dimethylamine salt, aminopyralid-monoethanolamine salt, aminopyralid-triisopropanolamine salt, and any combination thereof and more preferably from aminopyralid-potassium, aminopyralid-dimethylammonium, aminopyralid-triisopropanolamine salt, and any combination thereof. In particular, the herbicide B is aminopyralid-potassium.

Aminopyralid (i.e., 4-amino-3,6-dichloro-2-pyridinecarboxylic acid), as well as methods of making and using thereof, are known in the art, see, for example, U.S. Pat. No. 6,297,197. The herbicidal activity of aminopyralid is described, for example, in The Pesticide Manual, Fourteenth Edition, Editor: C. D. S. Tomlin, British Crop Production Council, 2006, entry 23, pages 30-31). Aminopyralid or salts thereof are commercially available, for example from Corteva Agriscience under the trademark MILESTONE™.

The oil-in-water emulsion formulation according to the invention may comprise the herbicide B (preferably a water-soluble salt of aminopyralid, in particular aminopyralid-potassium) in a concentration of at least 0.005% by weight, preferably at least 0.01% by weight, more preferably at least 0.05% by weight, most preferably at least 0.1% by weight, in particular at least 0.5% by weight, in each case based on the total weight of the formulation. The oil-in-water emulsion formulation of this invention may comprise the herbicide B (preferably a water-soluble salt of aminopyralid, in particular aminopyralid-potassium) in a concentration of up to 10% by weight, preferably up to 5% by weight, more preferably up to 1% by weight, in each case based on the total weight of the formulation. The oil-in-water emulsion formulation of this invention may comprise the herbicide B (preferably a water-soluble salt of aminopyralid, in particular aminopyralid-potassium) in a concentration of from 0.01 to 10% by weight, preferably 0.05 to 5% by weight, more preferably 0.1 to 2.5% by weight, most preferably 0.5 to 1% by weight, in each case based on the total weight of the formulation.

The concentrations of the herbicide B as given herein are calculated on an acid equivalent basis (i.e., the mere carboxylic acid such as, for example, aminopyralid).

The oil-in-water emulsion formulation according to the invention typically comprises water in a concentration of at least 5% by weight, preferably at least 10% by weight, more preferably at least 15% by weight, most preferably at least 20% by weight, in each case based on the total weight of the formulation. The oil-in-water emulsion formulation of this invention may comprise water in a concentration of up to 40% by weight, preferably up to 30% by weight, more preferably up to 25% by weight, in each case based on the total weight of the formulation. The oil-in-water emulsion formulation of this invention typically comprises water in a concentration of from 1 to 40% by weight, preferably 5 to 35% by weight, more preferably 10 to 30% by weight, most preferably 20 to 30% by weight, in each case based on the total weight of the formulation.

The oil-in-water emulsion formulation of this invention comprises c) a surfactant mixture C comprising at least two nonionic surfactants C.1 and C.2 and at least one anionic surfactant C.3. Preferably, the surfactant mixture C consists of two nonionic surfactants C.1 and C.2 and one anionic surfactant C.3.

Surfactants are compounds which reduce the surface tension of water. Nonionic and anionic surfactants suitable for use in the invention may be any known in the art.

The nonionic surfactants C.1 and C.2 are preferably selected from polyalkoxylated alkyl ethers, fatty alcohol polyglycol ethers and any combination thereof.

Polyalkoxylated alkyl ethers refer to polymers and copolymers. Copolymer refers to block co-polymers and/or random co-polymers. In some embodiments, alkoxy group refers but is not limited to ethylene oxide, propylene oxide, butylene oxide or combinations thereof. Examples of a polyalkoxylated alkyl ether are polyalkoxylated butyl ether, more specifically polyalkylene glycol butyl ether wherein the polyalkylene glycol unit is an ethylene oxide (EO)/propylene oxide (PO) block copolymer, e.g., the Ethylan® series such as Ethylan 1008, TD-100, DA-4, 1008 SA, NS 500 K, NS-500LQ, 1005 or TD3070 (commercially available from Nouryon).

The term “fatty alcohol” as used herein means primary or secondary alcohols having straight or branched chains which can be either saturated or unsaturated. Preferably, the alcohols are primary saturated alcohols. Especially preferred are linear or branched alcohols containing from 10 to 18 carbon atoms, more preferably 10 to 14 and still more preferably 12 to 14 carbon atoms. Examples include decyl, isodecyl, undecyl, dodecyl, tridecyl, isotridecyl, tetradecyl, pentadecyl, hexadecyl, heptadecyl and octadecyl alcohols, and mixtures thereof.

Thus, the fatty alcohol polyglycol ethers preferably contain 10 to 18, more preferably 10 to 14 and in particular 12 to 14 carbon atoms in the fatty alcohol residue. Still more preferably, the fatty alcohol polyglycol ethers contain 10 to 18 carbon atoms in the fatty alcohol residue and 2 to 20 ethylene oxide units in the polyglycol ether portion. Suitable fatty alcohol polyglycol ethers are, for example, C₁₀-C₁₈-, preferably C₁₀-C₁₄- and more preferably C₁₂-C₁₄-alcohol polyglycol ethers containing 2 to 20, preferably 3 to 15, ethylene oxide units, in particular isotridecyl alcohol polyglycol ethers, e.g., the Genapol® X series, such as Genapol® X-030, Genapol® X-060, Genapol® X-080 or Genapol® X-150 (all from Clariant).

The anionic surfactant C.3 is preferably selected from polyarylphenol polyalkoxyether sulfates and/or phosphates, C₈₋₁₈ alcohol polyalkoxyether phosphates, carboxylates, and/or citrates, and any combination thereof.

Exemplary polyarylphenol polyalkoxyether sulfates and phosphates include polyarylphenol polyethoxyether sulfates and phosphates, polyarylphenol polypropoxyether sulfates and phosphates, polyarylphenol poly(ethoxy/propoxy)ether sulfates and phosphates, and salts thereof. The term “aryl” as used herein includes, for example, phenyl, tolyl, naphthyl, tetrahydronaphthyl, indanyl, indenyl, styryl, pyridyl, quinolinyl, and any combination thereof. Exemplary polyarylphenol polyethoxyether sulfates and phosphates include distyrylphenol polyethoxyether sulfates and phosphates, and tristyrylphenol polyethoxyether sulfates and phosphates. The polyarylphenol polyalkoxether sulfates and phosphates preferably have a degree of alkoxylation (e.g., ethoxylation) of from 1 to 50, more preferably from 2 to 40 and in particular from 5 to 30. Commercially available polyarylphenol polyalkoxyether sulfates and phosphates include, for example, SOPROPHOR® 4 D 384 (tristyrylphenol (EO)₁₆ sulfate ammonium salt), SOPROPHOR® 3 D 33 (tristyrylphenol (EO)₁₆ phosphate free acid), SOPROPHOR® FLK (tristyrylphenol (EO)₁₆ phosphate potassium salt) and SOPROPHOR® RAM/384 (tristyrylphenol polyethoxylated ether sulfate neutralized with polyethoxylated oleylamine), all these products being available from Solvay. The term “EO” as used herein means an ethylene oxide unit.

Exemplary C-18 alcohol polyethoxyether phosphates, carboxylates and citrates include STEPFAC® 8180 (Stepan Company) (tridecylalcohol (EO)₃ phosphate), STEPFAC®8181 (Stepan Company) (tridecylalcohol (EO)₆ phosphate), STEPFAC®8182 (Stepan Company) (tridecylalcohol (EO)₁₂ phosphate), POLYSTEP® TD-6 (Stepan Company) (tridecylalcohol (EO)₆ carboxylate). The C₈₋₁₈ alcohol polyethoxyether phosphates, carboxylates and citrates may have a degree of ethoxylation of from 1 to 25, preferably from 1 to 20.

In another preferred embodiment, the surfactant mixture C comprises at least two nonionic surfactants C.1 and C.2 and at least one anionic surfactant C.3 wherein the nonionic surfactant C.1 has a HLB ranging from 8 to 12, preferably 10 to 12 and the nonionic surfactant C.2 has a HLB ranging from 12 to 18, preferably 12 to 16.

In yet another preferred embodiment, the surfactant mixture C consists of two nonionic surfactants C.1 and C.2 and one anionic surfactant C.3 wherein the nonionic surfactant C.1 has a HLB ranging from 8 to 12, preferably 10 to 12 and the nonionic surfactant C.2 has a HLB ranging from 12 to 18, preferably 12 to 16.

The HLB (Hydrophile-Lipophile-Balance) is an empirical scale defined by W. C. Griffin (J. Soc. Cosmetic Chemists, 1, 311 (1949)) which expresses the amphiphilic nature of emulsifying agents (particularly nonionic surfactants). The least hydrophilic surfactants are assigned the lowest HLB values.

In yet another preferred embodiment, the nonionic surfactant C.1 is selected from polyalkoxylated alkyl ethers, the nonionic surfactant C.2 is selected from C₁₀-C₁₄-alcohol polyglycol ethers and the anionic surfactant C.3 is selected from polyarylphenol polyalkoxy ether sulfates.

More preferably, the nonionic surfactant C.1 is a polyoxyalkalyted butyl ether, the nonionic surfactant C.2 is an iso-tridecyl alcohol polyglycol ether and the anionic surfactant C.3 is a tristyrylphenol ethoxylate sulfate ammonium salt.

Still more preferably, the nonionic surfactant C.1 is a polyalkylene glycol butyl ether wherein the polyalkylene glycol unit is an ethylene oxide/propylene oxide block copolymer, the nonionic surfactant C.2 is an iso-tridecyl alcohol polyglycol ether and the anionic surfactant C.3 is a tristyrylphenol ethoxylate sulfate ammonium salt.

The oil-in-water emulsion formulation according to the invention typically comprises the surfactant mixture C in a concentration of at least 0.1% by weight, preferably at least 0.5% by weight, more preferably at least 1% by weight, most preferably at least 3% by weight, in each case based on the total weight of the formulation. The oil-in-water emulsion formulation of this invention may comprise the surfactant mixture C in a concentration of up to 20% by weight, preferably up to 10% by weight, more preferably up to 7% by weight, most preferably up to 5% by weight, in each case based on the total weight of the formulation. The oil-in-water emulsion formulation of this invention typically comprises the surfactant mixture C in a concentration of from 0.1 to 20% by weight, preferably 0.5 to 10% by weight, more preferably 1 to 7% by weight, most preferably 3 to 5% by weight, in each case based on the total weight of the formulation.

The concentration of the nonionic surfactant C.1 is generally at least 0.1% by weight, preferably at least 0.5% by weight, more preferably at least 1% by weight, in each case based on the total weight of the formulation. The concentration of the nonionic surfactant C.1 is generally up to 10% by weight, preferably up to 5% by weight, more preferably up to 2.5% by weight, in each case based on the total weight of the formulation. The concentration of the nonionic surfactant C.1 is generally from 0.1 to 10% by weight, preferably 0.5 to 5% by weight, more preferably 1 to 2.5% by weight, in each case based on the total weight of the formulation.

The concentration of the nonionic surfactant C.2 is generally at least 0.1% by weight, preferably at least 0.5% by weight, more preferably at least 1% by weight, in each case based on the total weight of the formulation. The concentration of the nonionic surfactant C.2 is generally up to 10% by weight, preferably up to 5% by weight, more preferably up to 2.5% by weight, in each case based on the total weight of the formulation. The concentration of the nonionic surfactant C.2 is generally from 0.1 to 10% by weight, preferably 0.5 to 5% by weight, more preferably 1 to 2.5% by weight, in each case based on the total weight of the formulation.

The concentration of the anionic surfactant C.3 is generally at least 0.05% by weight, preferably at least 0.1% by weight, more preferably at least 0.5% by weight, in each case based on the total weight of the formulation. The concentration of the anionic surfactant C.3 is generally up to 5% by weight, preferably up to 3% by weight, more preferably up to 2% by weight, in each case based on the total weight of the formulation. The concentration of the anionic surfactant C.3 is generally from 0.05 to 5% by weight, preferably 0.1 to 3% by weight, more preferably 0.5 to 2% by weight, in each case based on the total weight of the formulation.

In a preferred embodiment, the oil-in-water emulsion formulation of this invention comprises a surfactant mixture C comprising (in particular consisting of) two nonionic surfactants C.1 and C.2 in a total amount of 0.1 to 10% by weight, preferably 0.5 to 7.5% by weight and more preferably 1 to 5% by weight, and one anionic surfactant C.3 in an amount of 0.05 to 5% by weight, preferably 0.1 to 3% by weight and more preferably 0.5 to 2% by weight, in each case based on the total weight of the formulation.

In a more preferred embodiment, the oil-in-water emulsion formulation of this invention comprises a surfactant mixture C comprising (in particular consisting of) a nonionic surfactant C.1 selected from polyalkoxylated alkyl ethers in an amount of 0.1 to 10% by weight, preferably 0.5 to 5% by weight and more preferably 1 to 2.5% by weight, a nonionic surfactant C.2 selected from C₁₀-C₁₄-alcohol polyglycol ethers in an amount of 0.1 to 10% by weight, preferably 0.5 to 5% by weight and more preferably 1 to 2.5% by weight, and an anionic surfactant C.3 selected from polyarylphenol polyalkoxy ether sulfates in an amount of 0.05 to 5% by weight, preferably 0.1 to 3% by weight and more preferably 0.5 to 2% by weight, in each case based on the total weight of the formulation.

In a particularly preferred embodiment, the surfactant mixture C comprises (in particular consists of) 0.5 to 5 wt. % of a nonionic surfactant C.1 which is a polyoxyalkalyted butyl ether, 0.5 to 5 wt. % of a nonionic surfactant C.2 which is an iso-tridecyl alcohol polyglycol ether and 0.1 to 3 wt. % of an anionic surfactant C.3 which is a tristyrylphenol ethoxylate sulfate ammonium salt wherein the amounts given in wt. % are each based on the total weight of the formulation.

In another embodiment, the oil-in-water emulsion formulation of this invention comprises a stabilizer D. Preferably, the formulation of this invention comprises a stabilizer D selected from polyvinylpyrrolidone, vinylpyrrolidone-vinyl acetate copolymers, microcrystalline cellulose, cellulose derivatives, alginates, and any combination thereof, more preferably selected from vinylpyrrolidone-vinyl acetate copolymers, microcrystalline cellulose, and any combination thereof.

Polyvinylpyrrolidones are, for example, Luviskol® K 90 characterized by a K index between 88 and 96 which refers to the viscosity of an aqueous solution containing 1% w/w of the polyvinyl pyrrolidone grade (commercially available from BASF SE).

Vinylpyrrolidone-vinyl acetate copolymers are copolymers of vinylpyrrolidone and vinyl acetate, which may be present in different ratios of vinylpyrrolidone (VP) to vinyl acetate (VA) and are commercially available. VP/VA copolymers having a higher vinylpyrrolidone content are water-soluble, for example starting from a VP content of 60%. It is preferred according to the invention if the vinylpyrrolidone-vinyl acetate copolymer has a weight ratio of vinylpyrrolidone (VP) to vinyl acetate (VA) of 30:70 to 70:30, preferably 50:70 to 30:50, very particularly 60:40. Preferred vinylpyrrolidone-vinyl acetate copolymers are available under the trade name Luviskol® VA 37, Luviskol® VA 55, Luviskol® VA 64, Luviskol® VA 73, in each case from BASF SE. In the present invention, the vinylpyrrolidone-vinyl acetate copolymer usually contains no further comonomers.

Microcrystalline cellulose suitable for the formulation according to the invention are preferably microcrystalline cellulose which are dispersible in water and are known by the trade name Lattice® NTC from IFF, such as, for example Lattice® NTC-50, Lattice® NTC-61 or Lattice® NTC-80. Cellulose derivatives as used herein include cellulose ethers such as methyl cellulose (MC), ethyl cellulose (EC), hydroxylpropylcellulose (HPC), hydroxylpropylmethylcellulose (HPMC), hydroxyethylcellulose (HEC), hydroxyethylmethylcellulose (HEMC) and carboxymethylcellulose (CMC), all of which are commercially available products.

Alginates as used herein are salts of alginic acid and include, for example, sodium alginate, potassium alginate or ammonium alginate, all of which are commercially available products.

In a particularly preferred embodiment of the invention, the stabilizer D comprises a vinylpyrrolidone/vinyl acetate copolymer having a ratio of vinylpyrrolidone (VP) to vinyl acetate (VA) of 50:70 to 30:50, preferably 60:40, and microcrystalline cellulose.

In an especially preferred embodiment of the invention, the stabilizer D comprises a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose.

The oil-in-water emulsion formulation according to the invention typically comprises the stabilizer D in a concentration of at least 0.01% by weight, preferably at least 0.1% by weight, more preferably at least 0.5% by weight, most preferably at least 1% by weight, in each case based on the total weight of the formulation. The oil-in-water emulsion formulation of this invention may comprise the stabilizer D in a concentration of up to 5% by weight, preferably up to 2.5% by weight, more preferably up to 2% by weight, in each case based on the total weight of the formulation. The oil-in-water emulsion formulation of this invention typically comprises the stabilizer D in a concentration of from 0.01 to 10% by weight, preferably 0.1 to 5% by weight, more preferably 0.5 to 3% by weight, most preferably 1 to 2% by weight, in each case based on the total weight of the formulation.

Particularly preferably, the oil-in-water emulsion formulation according to the invention comprises 0.5 to 3 wt. % (more preferably 1 to 2 wt. %) of a stabilizer D selected from vinylpyrrolidone-vinyl acetate copolymers, microcrystalline cellulose, and any combination thereof, wherein the amounts given in wt. % are based on the total weight of the formulation.

Especially preferably, the oil-in-water emulsion formulation according to the invention comprises 0.5 to 3 wt. % (more preferably 1 to 2 wt. %) of a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose, wherein the amounts given in wt. % are based on the total weight of the formulation.

The oil-in-water emulsion formulation of this invention optionally comprises an adjuvant E and preferably comprises an adjuvant E.

Adjuvants useful in this invention are compounds, which have a negligible or even no herbicidal activity themselves, and which improve the biological performance of the herbicides A and B on the target. Examples are surfactants, mineral or vegetable oils, and other auxiliaries. Further examples are listed by Knowles, Adjuvants and additives, Agrow Reports DS256, T&F Informa UK, 2006, chapter 5.

In a preferred embodiment, the oil-in-water emulsion formulation of this invention comprises an adjuvant E selected from ethylene oxide/propylene oxide block copolymers, alcohol alkoxylates, polyoxyalkylene sorbitan fatty acid esters, and any combination thereof, more preferably from polyoxyalkylene sorbitan fatty acid esters and in particular from polyoxyethylene sorbitan fatty acid esters.

Suitable ethylene oxide/propylene oxide block copolymers are commercially available, for example, under the trade names Pluronic®, such as Pluronic® PE 3100, PE 3500, PE 4300, PE 6100, PE 61200, PE 6200, PE 6400, PE 6800, PE 8100, PE 9200, PE 9400, PE 10100, PE 10400, and PE 10500 (all from BASF SE).

Suitable commercially available alcohol alkoxylates are, for example, the products of the Plurafac® LF series by BASF SE, such as Plurafac® LF 120, 223, 224, 400, 401, 403, 404, 131, 231, 132, 700, 1300, 1304 and 1430.

In the above polyoxyalkylene sorbitan fatty acid ester, the number of addition of the oxyalkylene moiety is preferably from 1 to 100, more preferably from 1 to 50, yet more preferably from 1 to 30 and in particular from 4 to 30. Further, the oxyalkylene moiety may be either linear or branched, and it preferably has, for example, from 2 to 3 carbon atoms. Specific examples thereof include ethylene oxide, propylene oxide and —CH(CH₃)CH₂O—. The oxyalkylene moiety may be a copolymer or a block copolymer, and the position of substitution of the oxyalkylene moiety is not particularly limited. The polyoxyalkylene sorbitan fatty acid ester may be any of a mono-fatty acid ester, a di-fatty acid ester and a tri-fatty acid ester. The fatty acid moiety of the polyoxyalkylene sorbitan fatty acid ester may be either a saturated fatty acid or an unsaturated fatty acid. The fatty acid moiety has preferably from 4 to 24, more preferably from 8 to 20 carbon atoms. The fatty acid moiety may be linear, branched or cyclic, and may have a substituent.

The number of the unsaturated bond(s) in the unsaturated fatty acid may be one or more, and the position is also optional. Specific examples of the fatty acid moiety include butyric acid, valeric acid, caproic acid, enanthic acid, caprylic acid, pelargonic acid, capric acid, lauric acid, myristic acid, pentadecylic acid, palmitic acid, palmitoleic acid, margaric acid, stearic acid, oleic acid, vaccenic acid, linoleic acid, (9,12,15)-linolenic acid, tuberculostearic acid, arachidic acid, arachidonic acid, behenic acid, erucic acid, lignoceric acid and nervonic acid.

Specific examples of the polyoxyalkylene sorbitan fatty acid ester, more specifically the polyoxyethylene sorbitan fatty acid ester, include, for example, polyoxyethylene sorbitan monolaurate, polyoxyethylene sorbitan dilaurate, polyoxyethylene sorbitan trilaurate, polyoxyethylene sorbitan monopalmitate, polyoxyethylene sorbitan dipalmitate, polyoxyethylene sorbitan tripalmitate, polyoxyethylene sorbitan monomyristate, polyoxyethylene sorbitan dimyristate, polyoxyethylene sorbitan trimyristate, polyoxyethylene sorbitan monostearate, polyoxyethylene sorbitan distearate, polyoxyethylene sorbitan tristearate, polyoxyethylene sorbitan monoisostearate, polyoxyethylene sorbitan diisostearate, polyoxyethylene sorbitan triisostearate, polyoxyethylene sorbitan monooleate, polyoxyethylene sorbitan dioleate, and polyoxyethylene sorbitan trioleate. The above adjuvants are all commercially available substances from different suppliers. In a particularly preferred embodiment, the adjuvant E is polyoxyethylene sorbitan monolaurate, more specifically polyoxyethylene (20) sorbitan monolaurate. Commercial brand names include Montanox® 20, Alkest® TW 20 and Tween® 20.

The oil-in-water emulsion formulation according to the invention typically comprises the adjuvant E in a concentration of at least 0.1% by weight, preferably at least 0.5% by weight, more preferably at least 1% by weight, most preferably at least 2% by weight, in each case based on the total weight of the formulation. The oil-in-water emulsion formulation of this invention may comprise the adjuvant E in a concentration of up to 20% by weight, preferably up to 15% by weight, more preferably up to 10% by weight, most preferably up to 8% by weight, in each case based on the total weight of the formulation. The oil-in-water emulsion formulation of this invention typically comprises the adjuvant E in a concentration of from 0.1 to 20% by weight, preferably 0.5 to 15% by weight, more preferably 1 to 10% by weight, most preferably 2 to 8% by weight, in each case based on the total weight of the formulation.

Particularly preferably, the oil-in-water emulsion formulation according to the invention comprises 0.5 to 15% wt. % (preferably 1 to 10% wt. %, more preferably 2 to 8% wt. %) of an adjuvant E selected from polyoxyalkylene sorbitan fatty acid esters, preferably from polyoxyethylene sorbitan fatty acid esters, wherein the amounts given in wt. % are based on the total weight of the formulation.

Especially preferably, the oil-in-water emulsion formulation according to the invention comprises 0.5 to 15% wt. % (preferably 1 to 10% wt. %, more preferably 2 to 8% wt. %) of an adjuvant E which is polyoxyethylene sorbitan monolaurate, preferably polyoxyethylene (20) sorbitan monolaurate, wherein the amounts given in wt. % are based on the total weight of the formulation.

The oil-in-water emulsion formulation of this invention optionally comprises one or more auxiliaries F and preferably comprises one or more auxiliaries F. The oil-in-water emulsion formulation of this invention typically comprises the auxiliaries F in a concentration of from 1 to 40% by weight, preferably 5 to 25% by weight, more preferably 10 to 20% by weight, in each case based on the total weight of the formulation. The auxiliaries F are preferably selected from antifreeze agents, anti-foaming agents, preservatives, colorants, UV absorbers, and any combination thereof, more preferably from antifreeze agents, anti-foaming agents, preservatives, and any combination thereof.

Possible antifreeze agents, anti-foaming agents, preservatives, colorants and UV absorbers are all substances which can customarily be employed in agrochemical formulations for this purpose.

Examples of suitable antifreeze agents are ethylene glycol, propylene glycol, urea and glycerin. The oil-in-water emulsion formulation of this invention optionally comprises the antifreeze agents in a concentration of from 1 to 30% by weight, preferably 5 to 20% by weight, more preferably 10 to 15% by weight, in each case based on the total weight of the formulation.

Examples of anti-foaming agents are silicones, long chain alcohols, and salts of fatty acids. Particularly preferred are silicone-based anti-foaming agents such as polydimethylsiloxanes such as, for example, SAG® 1529, SAG® 1538, SAG® 1571, SAG® 1572 and SAG® 1599 (all available from Momentive) and Silcolapse® 411, Silcolapse® 416, Silcolapse® 430, Silcolapse® 431, Silcolapse® 432, Silcolapse® 481 and Silcolapse® 482 (all available from Elkem). The oil-in-water emulsion formulation of this invention optionally comprises the anti-foaming agents in a concentration of from 0.005 to 2% by weight, preferably 0.01 to 1% by weight, more preferably 0.025 to 0.5% by weight, in each case based on the total weight of the formulation.

Examples of suitable preservatives are preparations based on isothiazolinone derivatives such as alkylisothiazolinones (e.g. 5-chloro-2-methyl-4-isothiazolin-3-one and 2-methyl-4-isothiazolin-3-one) and benzoisothiazolinones (e.g. 1,2-benzisothiazol-3(2H)-one), which are commercially available under the product series Acticide® from Thor GmbH, e.g. Acticide® MBS family, Acticide® B 20, Acticide® BW 20 and Acticide® MV. The oil-in-water emulsion formulation of this invention optionally comprises the preservatives in a concentration of from 0.01 to 3% by weight, preferably 0.05 to 1% by weight, more preferably 0.1 to 0.5% by weight, in each case based on the total weight of the formulation.

Suitable colorants are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants). Examples which may be mentioned are the dyes and pigments known by the names Rhodamin B, C. I. Pigment Red 112 and C. I. Solvent Red 1, Pigment blue 15:4, Pigment blue 15:3, Pigment blue 15:2, Pigment blue 15:1, Pigment blue 80, Pigment yellow 1, Pigment yellow 13, Pigment red 48:2, Pigment red 48:1, Pigment red 57:1, Pigment red 53:1, Pigment orange 43, Pigment orange 34, Pigment orange 5, Pigment green 36, Pigment green 7, Pigment white 6, Pigment brown 25, Basic violet 10, Basic violet 49, Acid red 51, Acid red 52, Acid red 14, Acid blue 9, Acid yellow 23, Basic red 10, Basic red 108.

The oil-in-water emulsion formulation of this invention optionally comprises the colorants in a concentration of from 0.05 to 2% by weight, preferably 0.1 to 1% by weight, more preferably 0.2 to 0.5% by weight, in each case based on the total weight of the formulation.

Suitable UV-absorbers are cinnamic esters, 3,3-diphenyl-2-cyano acrylates, hydroxy and/or alkoxy substituted benzophenones, N-(hydroxyphenyl)-benzotriazoles, hydroxyphenyl-s-triazines, oxalic amides and salicylates, e.g. UVINUL® 3000, 3008, 3040, 3048, 3049, 3050, 3030, 3035, 3039, 3088, UVINUL® MC80 from BTC Europe GmbH. The oil-in-water emulsion formulation of this invention optionally comprises the UV-absorbers in a concentration of from 0.1 to 10% by weight, preferably 0.25 to 5% by weight, more preferably 0.5 to 3% by weight, in each case based on the total weight of the formulation.

In another embodiment, the oil-in-water emulsion formulation of this invention optionally comprises at least one herbicide G which is different from the herbicides A and B and/or at least one safener H.

In a preferred embodiment, the herbicide G is selected from quinmerac, napropamide, napropamide-M, clomazone, bixlozone, broclozone and imazamox.

Safeners are chemical compounds which prevent or reduce damage on useful plants without having a major impact on the herbicidal action of the herbicidal active components of the present compositions towards unwanted plants. They can be applied either before sowings (e.g. on seed treatments, shoots or seedlings) or in the pre-emergence application or post-emergence application of the useful plant. The safeners H and the oil-in-water emulsion formulation of the invention and/or the herbicides G can be applied simultaneously or in succession.

Suitable safeners H are e.g. (quinolin-8-oxy)acetic acids, 1-phenyl-5-haloalkyl-1H-1,2,4-triazol-3-carboxylic acids, 1-phenyl-4,5-dihydro-5-alkyl-1H-pyrazol-3,5-dicarboxylic acids, 4,5-dihydro-5,5-diaryl-3-isoxazol carboxylic acids, dichloroacetamides, alpha-oximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenylcarbamates and their agriculturally acceptable salts and their agriculturally acceptable derivatives such amides, esters, and thioesters, provided they have an acid group.

Examples of preferred safeners H are benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4), metcamifen and BPCMS (CAS 54091-06-4).

Especially preferred safeners H are benoxacor, cloquintocet, cyprosulfamide, dichlormid, fenchlorazole, fenclorim, flurazole, fluxofenim, furilazole, isoxadifen, mefenpyr, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and metcamifen.

Particularly preferred safeners H are benoxacor, cloquintocet, cyprosulfamide, dichlormid, fenchlorazole, fenclorim, furilazole, isoxadifen, mefenpyr, naphthalic anhydride, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and metcamifen.

In a preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water, and
c) a surfactant mixture C comprising at least two nonionic surfactants C.1 and C.2 and at least one anionic surfactant C.3,
   wherein the non-polar solvent S1 is selected from aromatic hydrocarbons and the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate.

In another preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water, and
c) a surfactant mixture C comprising at least two nonionic surfactants C.1 and C.2 and at least one anionic surfactant C.3,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16.

In another preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water, and
c) a surfactant mixture C comprising at least two nonionic surfactants C.1 and C.2 and at least one anionic surfactant C.3,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is selected from polyalkoxylated alkyl ethers, the nonionic surfactant C.2 is selected from C₁₀-C₁₄-alcohol polyglycol ethers and the anionic surfactant C.3 is selected from polyarylphenol polyalkoxy ether sulfates.

In another preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water, and
c) a surfactant mixture C comprising at least two nonionic surfactants C.1 and C.2 and at least one anionic surfactant C.3,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is a polyoxyalkalyted butyl ether, the nonionic surfactant C.2 is an iso-tridecyl alcohol polyglycol ether and the anionic surfactant C.3 is a tristyrylphenol ethoxylate sulfate ammonium salt.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water, and
c) a surfactant mixture C comprising at least two nonionic surfactants C.1 and C.2 and at least one anionic surfactant C.3,
   wherein the non-polar solvent S1 is selected from aromatic hydrocarbons and the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water, and
c) a surfactant mixture C comprising at least two nonionic surfactants C.1 and C.2 and at least one anionic surfactant C.3,
   wherein the non-polar solvent S1 is selected from aromatic hydrocarbons and the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water, and
c) a surfactant mixture C comprising at least two nonionic surfactants C.1 and C.2 and at least one anionic surfactant C.3,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is selected from polyalkoxylated alkyl ethers, the nonionic surfactant C.2 is selected from C₁₀-C₁₄-alcohol polyglycol ethers and the anionic surfactant C.3 is selected from polyarylphenol polyalkoxy ether sulfates.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water, and
c) a surfactant mixture C comprising at least two nonionic surfactants C.1 and C.2 and at least one anionic surfactant C.3,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is a polyoxyalkalyted butyl ether, the nonionic surfactant C.2 is an iso-tridecyl alcohol polyglycol ether and the anionic surfactant C.3 is a tristyrylphenol ethoxylate sulfate ammonium salt.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water, and
c) a surfactant mixture C comprising at least two nonionic surfactants C.1 and C.2 and at least one anionic surfactant C.3,
   wherein the non-polar solvent S1 is selected from aromatic hydrocarbons and the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water, and
c) a surfactant mixture C comprising at least two nonionic surfactants C.1 and C.2 and at least one anionic surfactant C.3,
   wherein the non-polar solvent S1 is selected from aromatic hydrocarbons, the solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water, and
c) a surfactant mixture C comprising at least two nonionic surfactants C.1 and C.2 and at least one anionic surfactant C.3,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is selected from polyalkoxylated alkyl ethers, the nonionic surfactant C.2 is selected from C₁₀-C₁₄-alcohol polyglycol ethers and the anionic surfactant C.3 is selected from polyarylphenol polyalkoxy ether sulfates.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water, and
c) a surfactant mixture C comprising at least two nonionic surfactants C.1 and C.2 and at least one anionic surfactant C.3,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is a polyoxyalkalyted butyl ether, the nonionic surfactant C.2 is an iso-tridecyl alcohol polyglycol ether and the anionic surfactant C.3 is a tristyrylphenol ethoxylate sulfate ammonium salt.

In another preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water,
c) a surfactant mixture C comprising at least two nonionic surfactants C.1 and C.2 and at least one anionic surfactant C.3, and
d) a stabilizer D,
   wherein the non-polar solvent S1 is selected from aromatic hydrocarbons and the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate.

In another preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water,
c) a surfactant mixture C comprising at least two nonionic surfactants C.1 and C.2 and at least one anionic surfactant C.3, and
d) a stabilizer D selected from vinylpyrrolidone-vinyl acetate copolymers, microcrystalline cellulose, and any combination thereof,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16.

In another preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water,
c) a surfactant mixture C comprising a non-polar solvent S1 and a solvent S2 having a higher polarity than the non-polar solvent S1, and
d) a stabilizer D selected from vinylpyrrolidone-vinyl acetate copolymers, microcrystalline cellulose, and any combination thereof,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is selected from polyalkoxylated alkyl ethers, the nonionic surfactant C.2 is selected from C₁₀-C₁₄-alcohol polyglycol ethers and the anionic surfactant C.3 is selected from polyarylphenol polyalkoxy ether sulfates.

In another preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water,
c) a surfactant mixture C comprising at least two nonionic surfactants C.1 and C.2 and at least one anionic surfactant C.3 and
d) a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is a polyoxyalkalyted butyl ether, the nonionic surfactant C.2 is an iso-tridecyl alcohol polyglycol ether and the anionic surfactant C.3 is a tristyrylphenol ethoxylate sulfate ammonium salt.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water,
c) a surfactant mixture C comprising at least two nonionic surfactants C.1 and C.2 and at least one anionic surfactant C.3, and
d) a stabilizer D,
   wherein the non-polar solvent S1 is selected from aromatic hydrocarbons and the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water,
c) a surfactant mixture C comprising at least two nonionic surfactants C.1 and C.2 and at least one anionic surfactant C.3, and
d) a stabilizer D selected from vinylpyrrolidone-vinyl acetate copolymers, microcrystalline cellulose, and any combination thereof,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water,
c) a surfactant mixture C comprising at least two nonionic surfactants C.1 and C.2 and at least one anionic surfactant C.3, and
d) a stabilizer D selected from vinylpyrrolidone-vinyl acetate copolymers, microcrystalline cellulose, and any combination thereof,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is selected from polyalkoxylated alkyl ethers, the nonionic surfactant C.2 is selected from C₁₀-C₁₄-alcohol polyglycol ethers and the anionic surfactant C.3 is selected from polyarylphenol polyalkoxy ether sulfates.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water,
c) a surfactant mixture C comprising at least two nonionic surfactants C.1 and C.2 and at least one anionic surfactant C.3, and
d) a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is a polyoxyalkalyted butyl ether, the nonionic surfactant C.2 is an iso-tridecyl alcohol polyglycol ether and the anionic surfactant C.3 is a tristyrylphenol ethoxylate sulfate ammonium salt.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water,
c) a surfactant mixture C comprising at least two nonionic surfactants C.1 and C.2 and at least one anionic surfactant C.3, and
d) a stabilizer D,
   wherein the non-polar solvent S1 is selected from aromatic hydrocarbons and the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water,
c) a surfactant mixture C comprising at least two nonionic surfactants C.1 and C.2 and at least one anionic surfactant C.3, and
d) a stabilizer D selected from selected from vinylpyrrolidone-vinyl acetate copolymers, microcrystalline cellulose, and any combination thereof,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water,
c) a surfactant mixture C comprising at least two nonionic surfactants C.1 and C.2 and at least one anionic surfactant C.3, and
d) a stabilizer D selected from vinylpyrrolidone-vinyl acetate copolymers, microcrystalline cellulose, and any combination thereof,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is selected from polyalkoxylated alkyl ethers, the nonionic surfactant C.2 is selected from C₁₀-C₁₄-alcohol polyglycol ethers and the anionic surfactant C.3 is selected from polyarylphenol polyalkoxy ether sulfates.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water,
c) a surfactant mixture C comprising at least two nonionic surfactants C.1 and C.2 and at least one anionic surfactant C.3, and
d) a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is a polyoxyalkalyted butyl ether, the nonionic surfactant C.2 is an iso-tridecyl alcohol polyglycol ether and the anionic surfactant C.3 is a tristyrylphenol ethoxylate sulfate ammonium salt.

In another preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water,
c) a surfactant mixture C comprising at least two nonionic surfactants C.1 and C.2 and at least one anionic surfactant C.3,
d) a stabilizer D, and
e) an adjuvant E
   wherein the non-polar solvent S1 is selected from aromatic hydrocarbons and the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate.

In another preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water,
c) a surfactant mixture C comprising at least two nonionic surfactants C.1 and C.2 and at least one anionic surfactant C.3,
d) a stabilizer D selected from vinylpyrrolidone-vinyl acetate copolymers, microcrystalline cellulose, and any combination thereof, and
e) an adjuvant E selected from polyoxyalkylene sorbitan fatty acid esters, preferably from polyoxyethylene sorbitan fatty acid esters
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16.

In another preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water,
c) a surfactant mixture C comprising at least two nonionic surfactants C.1 and C.2 and at least one anionic surfactant C.3,
d) a stabilizer D selected from vinylpyrrolidone-vinyl acetate copolymers, microcrystalline cellulose, and any combination thereof, and
e) adjuvant E selected from polyoxyalkylene sorbitan fatty acid esters, preferably from polyoxyethylene sorbitan fatty acid esters
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is selected from polyalkoxylated alkyl ethers, the nonionic surfactant C.2 is selected from C₁₀-C₁₄-alcohol polyglycol ethers and the anionic surfactant C.3 is selected from polyarylphenol polyalkoxy ether sulfates.

In another preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water,
c) a surfactant mixture C comprising at least two nonionic surfactants C.1 and C.2 and at least one anionic surfactant C.3,
d) a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose, and
e) an adjuvant E which is polyoxyethylene sorbitan monolaurate, preferably polyoxyethylene (20) sorbitan monolaurate
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is a polyoxyalkalyted butyl ether, the nonionic surfactant C.2 is an iso-tridecyl alcohol polyglycol ether and the anionic surfactant C.3 is a tristyrylphenol ethoxylate sulfate ammonium salt.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water,
c) a surfactant mixture C comprising at least two nonionic surfactants C.1 and C.2 and at least one anionic surfactant C.3,
d) a stabilizer D, and
e) an adjuvant E
   wherein the non-polar solvent S1 is selected from aromatic hydrocarbons and the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water,
c) a surfactant mixture C comprising at least two nonionic surfactants C.1 and C.2 and at least one anionic surfactant C.3,
d) a stabilizer D selected from vinylpyrrolidone-vinyl acetate copolymers, microcrystalline cellulose, and any combination thereof, and
e) an adjuvant E selected from polyoxyalkylene sorbitan fatty acid esters, preferably from polyoxyethylene sorbitan fatty acid esters
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water,
c) a surfactant mixture C comprising at least two nonionic surfactants C.1 and C.2 and at least one anionic surfactant C.3,
d) a stabilizer D selected from vinylpyrrolidone-vinyl acetate copolymers, microcrystalline cellulose, and any combination thereof, and
e) an adjuvant E selected from polyoxyalkylene sorbitan fatty acid esters, preferably from polyoxyethylene sorbitan fatty acid esters
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is selected from polyalkoxylated alkyl ethers, the nonionic surfactant C.2 is selected from C₁₀-C₁₄-alcohol polyglycol ethers and the anionic surfactant C.3 is selected from polyarylphenol polyalkoxy ether sulfates.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water,
c) a surfactant mixture C comprising at least two nonionic surfactants C.1 and C.2 and at least one anionic surfactant C.3,
d) a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose, and
e) an adjuvant E which is polyoxyethylene sorbitan monolaurate, preferably polyoxyethylene (20) sorbitan monolaurate
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is a polyoxyalkalyted butyl ether, the nonionic surfactant C.2 is an iso-tridecyl alcohol polyglycol ether and the anionic surfactant C.3 is a tristyrylphenol ethoxylate sulfate ammonium salt.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water,
c) a surfactant mixture C comprising at least two nonionic surfactants C.1 and C.2 and at least one anionic surfactant C.3,
d) a stabilizer D, and
e) an adjuvant E
   wherein the non-polar solvent S1 is selected from aromatic hydrocarbons and the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water,
c) a surfactant mixture C comprising at least two nonionic surfactants C.1 and C.2 and at least one anionic surfactant C.3,
d) a stabilizer D selected from vinylpyrrolidone-vinyl acetate copolymers, microcrystalline cellulose, and any combination thereof, and
e) an adjuvant E selected from polyoxyalkylene sorbitan fatty acid esters, preferably from polyoxyethylene sorbitan fatty acid esters
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water,
c) a surfactant mixture C comprising at least two nonionic surfactants C.1 and C.2 and at least one anionic surfactant C.3,
d) a stabilizer D selected from vinylpyrrolidone-vinyl acetate copolymers, microcrystalline cellulose, and any combination thereof, and
e) an adjuvant E selected from polyoxyalkylene sorbitan fatty acid esters, preferably from polyoxyethylene sorbitan fatty acid esters
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is selected from polyalkoxylated alkyl ethers, the nonionic surfactant C.2 is selected from C₁₀-C₁₄-alcohol polyglycol ethers and the anionic surfactant C.3 is selected from polyarylphenol polyalkoxy ether sulfates.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water,
c) a surfactant mixture C comprising at least two nonionic surfactants C.1 and C.2 and at least one anionic surfactant C.3,
d) a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose, and
e) an adjuvant E which is polyoxyethylene sorbitan monolaurate, preferably polyoxyethylene (20) sorbitan monolaurate,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is a polyoxyalkalyted butyl ether, the nonionic surfactant C.2 is an iso-tridecyl alcohol polyglycol ether and the anionic surfactant C.3 is a tristyrylphenol ethoxylate sulfate ammonium salt.

In another preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water,
c) a surfactant mixture C comprising at least two nonionic surfactants C.1 and C.2 and at least one anionic surfactant C.3,
d) a stabilizer D,
e) optionally an adjuvant E, and
f) auxiliaries F,
   wherein the non-polar solvent S1 is selected from aromatic hydrocarbons and the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate.

In another preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water,
c) a surfactant mixture C comprising at least two nonionic surfactants C.1 and C.2 and at least one anionic surfactant C.3,
d) a stabilizer D selected from vinylpyrrolidone-vinyl acetate copolymers, microcrystalline cellulose, and any combination thereof,
e) optionally an adjuvant E selected from polyoxyalkylene sorbitan fatty acid esters, preferably from polyoxyethylene sorbitan fatty acid esters, and
f) auxiliaries F selected from antifreeze agents, anti-foaming agents, preservatives, and any combination thereof
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16.

In another preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water,
c) a surfactant mixture C comprising at least two nonionic surfactants C.1 and C.2 and at least one anionic surfactant C.3,
d) a stabilizer D selected from vinylpyrrolidone-vinyl acetate copolymers, microcrystalline cellulose, and any combination thereof,
e) optionally adjuvant E selected from polyoxyalkylene sorbitan fatty acid esters, preferably from polyoxyethylene sorbitan fatty acid esters, and
f) auxiliaries F selected from antifreeze agents, anti-foaming agents, preservatives, and any combination thereof
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is selected from polyalkoxylated alkyl ethers, the nonionic surfactant C.2 is selected from C₁₀-C₁₄-alcohol polyglycol ethers and the anionic surfactant C.3 is selected from polyarylphenol polyalkoxy ether sulfates.

In another preferred embodiment, the oil-in-water emulsion formulation of this invention comprises
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water,
c) a surfactant mixture C comprising at least two nonionic surfactants C.1 and C.2 and at least one anionic surfactant C.3,
d) a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose,
e) optionally an adjuvant E which is polyoxyethylene sorbitan monolaurate, preferably polyoxyethylene (20) sorbitan monolaurate, and
f) auxiliaries F selected from antifreeze agents, anti-foaming agents, preservatives, and any combination thereof,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is a polyoxyalkalyted butyl ether, the nonionic surfactant C.2 is an iso-tridecyl alcohol polyglycol ether and the anionic surfactant C.3 is a tristyrylphenol ethoxylate sulfate ammonium salt.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water,
c) a surfactant mixture C comprising at least two nonionic surfactants C.1 and C.2 and at least one anionic surfactant C.3,
d) a stabilizer D,
e) optionally an adjuvant E, and
f) auxiliaries F
   wherein the non-polar solvent S1 is selected from aromatic hydrocarbons and the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water,
c) a surfactant mixture C comprising at least two nonionic surfactants C.1 and C.2 and at least one anionic surfactant C.3,
d) a stabilizer D selected from vinylpyrrolidone-vinyl acetate copolymers, microcrystalline cellulose, and any combination thereof,
e) optionally an adjuvant E selected from polyoxyalkylene sorbitan fatty acid esters, preferably from polyoxyethylene sorbitan fatty acid esters, and
f) auxiliaries F selected from antifreeze agents, anti-foaming agents, preservatives, and any combination thereof
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water,
c) a surfactant mixture C comprising at least two nonionic surfactants C.1 and C.2 and at least one anionic surfactant C.3,
d) a stabilizer D selected from vinylpyrrolidone-vinyl acetate copolymers, microcrystalline cellulose, and any combination thereof,
e) optionally an adjuvant E selected from polyoxyalkylene sorbitan fatty acid esters, preferably from polyoxyethylene sorbitan fatty acid esters, and
f) auxiliaries F selected from antifreeze agents, anti-foaming agents, preservatives, and any combination thereof
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is selected from polyalkoxylated alkyl ethers, the nonionic surfactant C.2 is selected from C₁₀-C₁₄-alcohol polyglycol ethers and the anionic surfactant C.3 is selected from polyarylphenol polyalkoxy ether sulfates.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is a water-soluble salt of aminopyralid and water,
c) a surfactant mixture C comprising at least two nonionic surfactants C.1 and C.2 and at least one anionic surfactant C.3,
d) a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose,
e) optionally an adjuvant E which is polyoxyethylene sorbitan monolaurate, preferably polyoxyethylene (20) sorbitan monolaurate, and
f) auxiliaries F selected from antifreeze agents, anti-foaming agents, preservatives, and any combination thereof
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is a polyoxyalkalyted butyl ether, the nonionic surfactant C.2 is an iso-tridecyl alcohol polyglycol ether and the anionic surfactant C.3 is a tristyrylphenol ethoxylate sulfate ammonium salt.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water,
c) a surfactant mixture C comprising at least two nonionic surfactants C.1 and C.2 and at least one anionic surfactant C.3,
d) a stabilizer D,
e) optionally an adjuvant E, and
f) auxiliaries F
   wherein the non-polar solvent S1 is selected from aromatic hydrocarbons and the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water,
c) a surfactant mixture C comprising at least two nonionic surfactants C.1 and C.2 and at least one anionic surfactant C.3,
d) a stabilizer D selected from vinylpyrrolidone-vinyl acetate copolymers, microcrystalline cellulose, and any combination thereof,
e) optionally an adjuvant E selected from polyoxyalkylene sorbitan fatty acid esters, preferably from polyoxyethylene sorbitan fatty acid esters, and
f) auxiliaries F selected from antifreeze agents, anti-foaming agents, preservatives, and any combination thereof,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water,
c) a surfactant mixture C comprising at least two nonionic surfactants C.1 and C.2 and at least one anionic surfactant C.3,
d) a stabilizer D selected from vinylpyrrolidone-vinyl acetate copolymers, microcrystalline cellulose, and any combination thereof,
e) optionally an adjuvant E selected from polyoxyalkylene sorbitan fatty acid esters, preferably from polyoxyethylene sorbitan fatty acid esters, and
f) auxiliaries F selected from antifreeze agents, anti-foaming agents, preservatives, and any combination thereof
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is selected from polyalkoxylated alkyl ethers, the nonionic surfactant C.2 is selected from C₁₀-C₁₄-alcohol polyglycol ethers and the anionic surfactant C.3 is selected from polyarylphenol polyalkoxy ether sulfates.

In another preferred embodiment, the oil-in-water emulsion formulation of this invention comprises
a) a discontinuous oil phase comprising a herbicide A which is dimethenamid-P and a solvent mixture S comprising a non-polar solvent S1 and a solvent S2 having a higher polarity than the non-polar solvent S1,
b) a continuous aqueous phase comprising a herbicide B which is aminopyralid-potassium and water,
c) a surfactant mixture C comprising at least two nonionic surfactants C.1 and C.2 and at least one anionic surfactant C.3,
d) a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose,
e) optionally an adjuvant E which is polyoxyethylene sorbitan monolaurate, preferably polyoxyethylene (20) sorbitan monolaurate, and
f) auxiliaries F selected from antifreeze agents, anti-foaming agents, preservatives, and any combination thereof
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 is a polyoxyalkalyted butyl ether, the nonionic surfactant C.2 is an iso-tridecyl alcohol polyglycol ether and the anionic surfactant C.3 is a tristyrylphenol ethoxylate sulfate ammonium salt.

In another preferred embodiment, the oil-in-water emulsion formulation of this invention comprises
a) a discontinuous oil phase comprising 10 to 70 wt. % of a herbicide A selected from chloroacetamide herbicides and 1 to 30 wt. % of a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water, and
c) 1 to 20 wt. % of a surfactant mixture C comprising at least two nonionic surfactants C.1 and C.2 and at least one anionic surfactant C.3,
   wherein the non-polar solvent S1 is selected from aromatic hydrocarbons and the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate and the amounts given in wt. % are each based on the total weight of the formulation.

In another preferred embodiment, the oil-in-water emulsion formulation of this invention comprises
a) a discontinuous oil phase comprising 10 to 70 wt. % of a herbicide A selected from chloroacetamide herbicides and 1 to 30 wt. % of a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water, and
c) 1 to 20 wt. % of a surfactant mixture C comprising at least two nonionic surfactants C.1 and C.2 and at least one anionic surfactant C.3,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16 and the amounts given in wt. % are each based on the total weight of the formulation.

In another preferred embodiment, the oil-in-water emulsion formulation of this invention comprises
a) a discontinuous oil phase comprising 10 to 70 wt. % of a herbicide A selected from chloroacetamide herbicides and a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water, and
c) a surfactant mixture C comprising at least two nonionic surfactants C.1 and C.2 and at least one anionic surfactant C.3,
   wherein the solvent mixture S comprises 3 to 25 wt. %, preferably 4 to 15 wt. %, more preferably 4 to 10 wt. % of the non-polar solvent S1 selected from aromatic hydrocarbons and 1 to 10 wt. %, preferably 2.5 to 8 wt. %, more preferably 4 to 7 wt. % of the solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.1 to 10 wt. % of the nonionic surfactant C.1 selected from polyalkoxylated alkyl ethers, 0.1 to 10 wt. % of the nonionic surfactant C.2 selected from C₁₀-C₁₄-alcohol polyglycol ethers and 0.05 to 5 wt. % of the anionic surfactant C.3 selected from polyarylphenol polyalkoxy ether sulfates and the amounts given in wt. % are each based on the total weight of the formulation.

In another preferred embodiment, the oil-in-water emulsion formulation of this invention comprises
a) a discontinuous oil phase comprising 10 to 70 wt. % of a herbicide A selected from chloroacetamide herbicides and a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water, and
c) a surfactant mixture C comprising at least two nonionic surfactants C.1 and C.2 and at least one anionic surfactant C.3,
   wherein the solvent mixture S comprises 3 to 25 wt. %, preferably 4 to 15 wt. %, more preferably 4 to 10 wt. % of a non-polar solvent S1 selected from aromatic hydrocarbons and 1 to 10 wt. %, preferably 2.5 to 8 wt. %, more preferably 4 to 7 wt. % of a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.5 to 5 wt. % of the nonionic surfactant C.1 which is a polyoxyalkalyted butyl ether, 0.5 to 5 wt. % of the nonionic surfactant C.2 which is an iso-tridecyl alcohol polyglycol ether and 0.1 to 3 wt. % of the anionic surfactant C.3 which is a tristyrylphenol ethoxylate sulfate ammonium salt and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water, and
c) 1 to 20 wt. % of a surfactant mixture C comprising at least two nonionic surfactants C.1 and C.2 and at least one anionic surfactant C.3,
   wherein the solvent mixture S comprises a non-polar solvent S1 selected from aromatic hydrocarbons and a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water, and
c) 1 to 20 wt. % of a surfactant mixture C comprising at least two nonionic surfactants C.1 and C.2 and at least one anionic surfactant C.3,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16 and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water, and
c) a surfactant mixture C comprising at least two nonionic surfactants C.1 and C.2 and at least one anionic surfactant C.3,
   wherein the solvent mixture S comprises 3 to 25 wt. %, preferably 4 to 15 wt. %, more preferably 4 to 10 wt. % of the non-polar solvent S1 selected from aromatic hydrocarbons and 1 to 10 wt. %, preferably 2.5 to 8 wt. %, more preferably 4 to 7 wt. % of the solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.1 to 10 wt. % of the nonionic surfactant C.1 selected from polyalkoxylated alkyl ethers, 0.1 to 10 wt. % of the nonionic surfactant C.2 selected from C₁₀-C₁₄-alcohol polyglycol ethers and 0.05 to 5 wt. % of the anionic surfactant C.3 selected from polyarylphenol polyalkoxy ether sulfates and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water, and
c) a surfactant mixture C comprising at least two nonionic surfactants C.1 and C.2 and at least one anionic surfactant C.3,
   wherein the solvent mixture S comprises 3 to 25 wt. %, preferably 4 to 15 wt. %, more preferably 4 to 10 wt. % of a non-polar solvent S1 selected from aromatic hydrocarbons and 1 to 10 wt. %, preferably 2.5 to 8 wt. %, more preferably 4 to 7 wt. % of a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.5 to 5 wt. % of the nonionic surfactant C.1 which is a polyoxyalkalyted butyl ether, 0.5 to 5 wt. % of the nonionic surfactant C.2 which is an iso-tridecyl alcohol polyglycol ether and 0.1 to 3 wt. % of the anionic surfactant C.3 which is a tristyrylphenol ethoxylate sulfate ammonium salt and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water, and
c) 1 to 20 wt. % of a surfactant mixture C comprising at least two nonionic surfactants C.1 and C.2 and at least one anionic surfactant C.3,
   wherein the solvent mixture S comprises a non-polar solvent S1 selected from aromatic hydrocarbons and a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water, and
c) 1 to 20 wt. % of a surfactant mixture C comprising at least two nonionic surfactants C.1 and C.2 and at least one anionic surfactant C.3,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16 and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water, and
c) a surfactant mixture C comprising at least two nonionic surfactants C.1 and C.2 and at least one anionic surfactant C.3,
   wherein the solvent mixture S comprises 3 to 25 wt. %, preferably 4 to 15 wt. %, more preferably 4 to 10 wt. % of the non-polar solvent S1 selected from aromatic hydrocarbons and 1 to 10 wt. %, preferably 2.5 to 8 wt. %, more preferably 4 to 7 wt. % of the solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.1 to 10 wt. % of the nonionic surfactant C.1 selected from polyalkoxylated alkyl ethers, 0.1 to 10 wt. % of the nonionic surfactant C.2 selected from C₁₀-C₁₄-alcohol polyglycol ethers and 0.05 to 5 wt. % of the anionic surfactant C.3 selected from polyarylphenol polyalkoxy ether sulfates and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water, and
c) a surfactant mixture C comprising at least two nonionic surfactants C.1 and C.2 and at least one anionic surfactant C.3,
   wherein the solvent mixture S comprises 3 to 25 wt. %, preferably 4 to 15 wt. %, more preferably 4 to 10 wt. % of a non-polar solvent S1 selected from aromatic hydrocarbons and 1 to 10 wt. %, preferably 2.5 to 8 wt. %, more preferably 4 to 7 wt. % of a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.5 to 5 wt. % of the nonionic surfactant C.1 which is a polyoxyalkalyted butyl ether, 0.5 to 5 wt. % of the nonionic surfactant C.2 which is an iso-tridecyl alcohol polyglycol ether and 0.1 to 3 wt. % of the anionic surfactant C.3 which is a tristyrylphenol ethoxylate sulfate ammonium salt and the amounts given in wt. % are each based on the total weight of the formulation.

In another preferred embodiment, the oil-in-water emulsion formulation of this invention comprises
a) a discontinuous oil phase comprising 10 to 70 wt. % of a herbicide A selected from chloroacetamide herbicides and 1 to 30 wt. % of a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water,
c) 1 to 20 wt. % of a surfactant mixture C comprising at least two nonionic surfactants C.1 and C.2 and at least one anionic surfactant C.3, and
d) 0.01 to 10 wt. % of a stabilizer D,
   wherein the solvent mixture S comprises a non-polar solvent S1 selected from aromatic hydrocarbons and a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate and the amounts given in wt. % are each based on the total weight of the formulation.

In another preferred embodiment, the oil-in-water emulsion formulation of this invention comprises
a) a discontinuous oil phase comprising 10 to 70 wt. % of a herbicide A selected from chloroacetamide herbicides and 1 to 30 wt. % of a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water,
c) 1 to 20 wt. % of a surfactant mixture C comprising at least two nonionic surfactants C.1 and C.2 and at least one anionic surfactant C.3, and
d) 0.1 to 5 wt. % of a stabilizer D selected from vinylpyrrolidone-vinyl acetate copolymers, microcrystalline cellulose, and any combination thereof,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16 and the amounts given in wt. % are each based on the total weight of the formulation.

In another preferred embodiment, the oil-in-water emulsion formulation of this invention comprises
a) a discontinuous oil phase comprising 10 to 70 wt. % of a herbicide A selected from chloroacetamide herbicides and a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water,
c) a surfactant mixture C comprising at least two nonionic surfactants C.1 and C.2 and at least one anionic surfactant C.3, and
d) 0.1 to 5 wt. % of a stabilizer D selected from vinylpyrrolidone-vinyl acetate copolymers, microcrystalline cellulose, and any combination thereof,
   wherein the solvent mixture S comprises 3 to 25 wt. %, preferably 4 to 15 wt. %, more preferably 4 to 10 wt. % of the non-polar solvent S1 selected from aromatic hydrocarbons and 1 to 10 wt. %, preferably 2.5 to 8 wt. %, more preferably 4 to 7 wt. % of the solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.1 to 10 wt. % of the nonionic surfactant C.1 selected from polyalkoxylated alkyl ethers, 0.1 to 10 wt. % of the nonionic surfactant C.2 selected from C₁₀-C₁₄-alcohol polyglycol ethers and 0.05 to 5 wt. % of the anionic surfactant C.3 selected from polyarylphenol polyalkoxy ether sulfates and the amounts given in wt. % are each based on the total weight of the formulation.

In another preferred embodiment, the oil-in-water emulsion formulation of this invention comprises
a) a discontinuous oil phase comprising 10 to 70 wt. % of a herbicide A selected from chloroacetamide herbicides and a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water,
c) a surfactant mixture C comprising at least two nonionic surfactants C.1 and C.2 and at least one anionic surfactant C.3, and
d) 0.5 to 3 wt. % of a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose,
   wherein the solvent mixture S comprises 3 to 25 wt. %, preferably 4 to 15 wt. %, more preferably 4 to 10 wt. % of a non-polar solvent S1 selected from aromatic hydrocarbons and 1 to 10 wt. %, preferably 2.5 to 8 wt. %, more preferably 4 to 7 wt. % of a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.5 to 5 wt. % of the nonionic surfactant C.1 which is a polyoxyalkalyted butyl ether, 0.5 to 5 wt. % of the nonionic surfactant C.2 which is an iso-tridecyl alcohol polyglycol ether and 0.1 to 3 wt. % of the anionic surfactant C.3 which is a tristyrylphenol ethoxylate sulfate ammonium salt and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water,
c) 1 to 20 wt. % of a surfactant mixture C comprising at least two nonionic surfactants C.1 and C.2 and at least one anionic surfactant C.3, and
d) 0.01 to 10 wt. % of a stabilizer D,
   wherein the solvent mixture S comprises a non-polar solvent S1 selected from aromatic hydrocarbons and a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water,
c) 1 to 20 wt. % of a surfactant mixture C comprising at least two nonionic surfactants C.1 and C.2 and at least one anionic surfactant C.3, and
d) 0.1 to 5 wt. % of a stabilizer D selected from vinylpyrrolidone-vinyl acetate copolymers, microcrystalline cellulose, and any combination thereof,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16 and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water,
c) a surfactant mixture C comprising at least two nonionic surfactants C.1 and C.2 and at least one anionic surfactant C.3, and
d) 0.1 to 5 wt. % of a stabilizer D selected from vinylpyrrolidone-vinyl acetate copolymers, microcrystalline cellulose, and any combination thereof,
   wherein the solvent mixture S comprises 3 to 25 wt. %, preferably 4 to 15 wt. %, more preferably 4 to 10 wt. % of the non-polar solvent S1 selected from aromatic hydrocarbons and 1 to 10 wt. %, preferably 2.5 to 8 wt. %, more preferably 4 to 7 wt. % of the solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.1 to 10 wt. % of the nonionic surfactant C.1 selected from polyalkoxylated alkyl ethers, 0.1 to 10 wt. % of the nonionic surfactant C.2 selected from C₁₀-C₁₄-alcohol polyglycol ethers and 0.05 to 5 wt. % of the anionic surfactant C.3 selected from polyarylphenol polyalkoxy ether sulfates and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water,
c) a surfactant mixture C comprising at least two nonionic surfactants C.1 and C.2 and at least one anionic surfactant C.3, and
d) 0.5 to 3 wt. % of a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose,
   wherein the solvent mixture S comprises 3 to 25 wt. %, preferably 4 to 15 wt. %, more preferably 4 to 10 wt. % of a non-polar solvent S1 selected from aromatic hydrocarbons and 1 to 10 wt. %, preferably 2.5 to 8 wt. %, more preferably 4 to 7 wt. % of a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.5 to 5 wt. % of the nonionic surfactant C.1 which is a polyoxyalkalyted butyl ether, 0.5 to 5 wt. % of the nonionic surfactant C.2 which is an iso-tridecyl alcohol polyglycol ether and 0.1 to 3 wt. % of the anionic surfactant C.3 which is a tristyrylphenol ethoxylate sulfate ammonium salt and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water,
c) 1 to 20 wt. % of a surfactant mixture C comprising at least two nonionic surfactants C.1 and C.2 and at least one anionic surfactant C.3, and
d) 0.01 to 10 wt. % of a stabilizer D,
   wherein the solvent mixture S comprises a non-polar solvent S1 selected from aromatic hydrocarbons and a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water,
c) 1 to 20 wt. % of a surfactant mixture C comprising at least two nonionic surfactants C.1 and C.2 and at least one anionic surfactant C.3, and
d) 0.1 to 5 wt. % of a stabilizer D selected from vinylpyrrolidone-vinyl acetate copolymers, microcrystalline cellulose, and any combination thereof,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16 and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water,
c) a surfactant mixture C comprising at least two nonionic surfactants C.1 and C.2 and at least one anionic surfactant C.3, and
d) 0.1 to 5 wt. % of a stabilizer D selected from vinylpyrrolidone-vinyl acetate copolymers, microcrystalline cellulose, and any combination thereof,
   wherein the solvent mixture S comprises 3 to 25 wt. %, preferably 4 to 15 wt. %, more preferably 4 to 10 wt. % of the non-polar solvent S1 selected from aromatic hydrocarbons and 1 to 10 wt. %, preferably 2.5 to 8 wt. %, more preferably 4 to 7 wt. % of the solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.1 to 10 wt. % of the nonionic surfactant C.1 selected from polyalkoxylated alkyl ethers, 0.1 to 10 wt. % of the nonionic surfactant C.2 selected from C₁₀-C₁₄-alcohol polyglycol ethers and 0.05 to 5 wt. % of the anionic surfactant C.3 selected from polyarylphenol polyalkoxy ether sulfates and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water,
c) a surfactant mixture C comprising at least two nonionic surfactants C.1 and C.2 and at least one anionic surfactant C.3, and
d) 0.5 to 3 wt. % of a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose,
   wherein the solvent mixture S comprises 3 to 25 wt. %, preferably 4 to 15 wt. %, more preferably 4 to 10 wt. % of a non-polar solvent S1 selected from aromatic hydrocarbons and 1 to 10 wt. %, preferably 2.5 to 8 wt. %, more preferably 4 to 7 wt. % of a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.5 to 5 wt. % of the nonionic surfactant C.1 which is a polyoxyalkalyted butyl ether, 0.5 to 5 wt. % of the nonionic surfactant C.2 which is an iso-tridecyl alcohol polyglycol ether and 0.1 to 3 wt. % of the anionic surfactant C.3 which is a tristyrylphenol ethoxylate sulfate ammonium salt and the amounts given in wt. % are each based on the total weight of the formulation.

In another preferred embodiment, the oil-in-water emulsion formulation of this invention comprises
a) a discontinuous oil phase comprising 10 to 70 wt. % of a herbicide A selected from chloroacetamide herbicides and 1 to 30 wt. % of a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water,
c) 1 to 20 wt. % of a surfactant mixture C comprising at least two nonionic surfactants C.1 and C.2 and at least one anionic surfactant C.3,
d) 0.01 to 10 wt. % of a stabilizer D, and
e) 0.1 to 20 wt. % of an adjuvant E,
   wherein the solvent mixture S comprises a non-polar solvent S1 selected from aromatic hydrocarbons and a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate and the amounts given in wt. % are each based on the total weight of the formulation.

In another preferred embodiment, the oil-in-water emulsion formulation of this invention comprises
a) a discontinuous oil phase comprising 10 to 70 wt. % of a herbicide A selected from chloroacetamide herbicides and 1 to 30 wt. % of a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water,
c) 1 to 20 wt. % of a surfactant mixture C comprising at least two nonionic surfactants C.1 and C.2 and at least one anionic surfactant C.3,
d) 0.1 to 5 wt. % of a stabilizer D selected from vinylpyrrolidone-vinyl acetate copolymers, microcrystalline cellulose, and any combination thereof, and
e) 0.5 to 15 wt. % of an adjuvant E selected from polyoxyalkylene sorbitan fatty acid esters, preferably from polyoxyethylene sorbitan fatty acid esters,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16 and the amounts given in wt. % are each based on the total weight of the formulation.

In another preferred embodiment, the oil-in-water emulsion formulation of this invention comprises
a) a discontinuous oil phase comprising 10 to 70 wt. % of a herbicide A selected from chloroacetamide herbicides and a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water,
c) a surfactant mixture C comprising at least two nonionic surfactants C.1 and C.2 and at least one anionic surfactant C.3,
d) 0.1 to 5 wt. % of a stabilizer D selected from vinylpyrrolidone-vinyl acetate copolymers, microcrystalline cellulose, and any combination thereof, and
e) 0.5 to 15 wt. % of an adjuvant E selected from polyoxyalkylene sorbitan fatty acid esters, preferably from polyoxyethylene sorbitan fatty acid esters,
   wherein the solvent mixture S comprises 3 to 25 wt. %, preferably 4 to 15 wt. %, more preferably 4 to 10 wt. % of the non-polar solvent S1 selected from aromatic hydrocarbons and 1 to 10 wt. %, preferably 2.5 to 8 wt. %, more preferably 4 to 7 wt. % of the solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.1 to 10 wt. % of the nonionic surfactant C.1 selected from polyalkoxylated alkyl ethers, 0.1 to 10 wt. % of the nonionic surfactant C.2 selected from C₁₀-C₁₄-alcohol polyglycol ethers and 0.05 to 5 wt. % of the anionic surfactant C.3 selected from polyarylphenol polyalkoxy ether sulfates and the amounts given in wt. % are each based on the total weight of the formulation.

In another preferred embodiment, the oil-in-water emulsion formulation of this invention comprises
a) a discontinuous oil phase comprising 10 to 70 wt. % of a herbicide A selected from chloroacetamide herbicides and a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water,
c) a surfactant mixture C comprising at least two nonionic surfactants C.1 and C.2 and at least one anionic surfactant C.3,
d) 0.5 to 3 wt. % of a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose, and
e) 1 to 10 wt. % of an adjuvant E which is polyoxyethylene sorbitan monolaurate, preferably polyoxyethylene (20) sorbitan monolaurate,
   wherein the solvent mixture S comprises 3 to 25 wt. %, preferably 4 to 15 wt. %, more preferably 4 to 10 wt. % of a non-polar solvent S1 selected from aromatic hydrocarbons and 1 to 10 wt. %, preferably 2.5 to 8 wt. %, more preferably 4 to 7 wt. % of a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.5 to 5 wt. % of the nonionic surfactant C.1 which is a polyoxyalkalyted butyl ether, 0.5 to 5 wt. % of the nonionic surfactant C.2 which is an iso-tridecyl alcohol polyglycol ether and 0.1 to 3 wt. % of the anionic surfactant C.3 which is a tristyrylphenol ethoxylate sulfate ammonium salt and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water,
c) 1 to 20 wt. % of a surfactant mixture C comprising at least two nonionic surfactants C.1 and C.2 and at least one anionic surfactant C.3,
d) 0.01 to 10 wt. % of a stabilizer D, and
e) 0.1 to 20 wt. % of an adjuvant E,
   wherein the solvent mixture S comprises a non-polar solvent S1 selected from aromatic hydrocarbons and a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water,
c) 1 to 20 wt. % of a surfactant mixture C comprising at least two nonionic surfactants C.1 and C.2 and at least one anionic surfactant C.3,
d) 0.1 to 5 wt. % of a stabilizer D selected from vinylpyrrolidone-vinyl acetate copolymers, microcrystalline cellulose, and any combination thereof, and
e) 0.5 to 15 wt. % of an adjuvant E selected from polyoxyalkylene sorbitan fatty acid esters, preferably from polyoxyethylene sorbitan fatty acid esters,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16 and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water,
c) a surfactant mixture C comprising at least two nonionic surfactants C.1 and C.2 and at least one anionic surfactant C.3,
d) 0.1 to 5 wt. % of a stabilizer D selected from vinylpyrrolidone-vinyl acetate copolymers, microcrystalline cellulose, and any combination thereof, and
e) 0.5 to 15 wt. % of an adjuvant E selected from polyoxyalkylene sorbitan fatty acid esters, preferably from polyoxyethylene sorbitan fatty acid esters,
   wherein the solvent mixture S comprises 3 to 25 wt. %, preferably 4 to 15 wt. %, more preferably 4 to 10 wt. % of the non-polar solvent S1 selected from aromatic hydrocarbons and 1 to 10 wt. %, preferably 2.5 to 8 wt. %, more preferably 4 to 7 wt. % of the solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.1 to 10 wt. % of the nonionic surfactant C.1 selected from polyalkoxylated alkyl ethers, 0.1 to 10 wt. % of the nonionic surfactant C.2 selected from C₁₀-C₁₄-alcohol polyglycol ethers and 0.05 to 5 wt. % of the anionic surfactant C.3 selected from polyarylphenol polyalkoxy ether sulfates and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water,
c) a surfactant mixture C comprising at least two nonionic surfactants C.1 and C.2 and at least one anionic surfactant C.3,
d) 0.5 to 3 wt. % of a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose, and
e) 1 to 10 wt. % of an adjuvant E which is polyoxyethylene sorbitan monolaurate, preferably polyoxyethylene (20) sorbitan monolaurate,
   wherein the solvent mixture S comprises 3 to 25 wt. %, preferably 4 to 15 wt. %, more preferably 4 to 10 wt. % of a non-polar solvent S1 selected from aromatic hydrocarbons and 1 to 10 wt. %, preferably 2.5 to 8 wt. %, more preferably 4 to 7 wt. % of a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.5 to 5 wt. % of the nonionic surfactant C.1 which is a polyoxyalkalyted butyl ether, 0.5 to 5 wt. % of the nonionic surfactant C.2 which is an iso-tridecyl alcohol polyglycol ether and 0.1 to 3 wt. % of the anionic surfactant C.3 which is a tristyrylphenol ethoxylate sulfate ammonium salt and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water,
c) 1 to 20 wt. % of a surfactant mixture C comprising at least two nonionic surfactants C.1 and C.2 and at least one anionic surfactant C.3,
d) 0.01 to 10 wt. % of a stabilizer D, and
e) 0.1 to 20 wt. % of an adjuvant E,
   wherein the solvent mixture S comprises a non-polar solvent S1 selected from aromatic hydrocarbons and a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water,
c) 1 to 20 wt. % of a surfactant mixture C comprising at least two nonionic surfactants C.1 and C.2 and at least one anionic surfactant C.3,
d) 0.1 to 5 wt. % of a stabilizer D selected from vinylpyrrolidone-vinyl acetate copolymers, microcrystalline cellulose, and any combination thereof, and
e) 0.5 to 15 wt. % of an adjuvant E selected from polyoxyalkylene sorbitan fatty acid esters, preferably from polyoxyethylene sorbitan fatty acid esters,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16 and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water,
c) a surfactant mixture C comprising at least two nonionic surfactants C.1 and C.2 and at least one anionic surfactant C.3,
d) 0.1 to 5 wt. % of a stabilizer D selected from vinylpyrrolidone-vinyl acetate copolymers, microcrystalline cellulose, and any combination thereof, and
e) 0.5 to 15 wt. % of an adjuvant E selected from polyoxyalkylene sorbitan fatty acid esters, preferably from polyoxyethylene sorbitan fatty acid esters,
   wherein the solvent mixture S comprises 3 to 25 wt. %, preferably 4 to 15 wt. %, more preferably 4 to 10 wt. % of the non-polar solvent S1 selected from aromatic hydrocarbons and 1 to 10 wt. %, preferably 2.5 to 8 wt. %, more preferably 4 to 7 wt. % of the solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.1 to 10 wt. % of the nonionic surfactant C.1 selected from polyalkoxylated alkyl ethers, 0.1 to 10 wt. % of the nonionic surfactant C.2 selected from C₁₀-C₁₄-alcohol polyglycol ethers and 0.05 to 5 wt. % of the anionic surfactant C.3 selected from polyarylphenol polyalkoxy ether sulfates and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water,
c) a surfactant mixture C comprising at least two nonionic surfactants C.1 and C.2 and at least one anionic surfactant C.3,
d) 0.5 to 3 wt. % of a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose, and
e) 1 to 10 wt. % of an adjuvant E which is polyoxyethylene sorbitan monolaurate, preferably polyoxyethylene (20) sorbitan monolaurate,
   wherein the solvent mixture S comprises 3 to 25 wt. %, preferably 4 to 15 wt. %, more preferably 4 to 10 wt. % of a non-polar solvent S1 selected from aromatic hydrocarbons and 1 to 10 wt. %, preferably 2.5 to 8 wt. %, more preferably 4 to 7 wt. % of a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.5 to 5 wt. % of the nonionic surfactant C.1 which is a polyoxyalkalyted butyl ether, 0.5 to 5 wt. % of the nonionic surfactant C.2 which is an iso-tridecyl alcohol polyglycol ether and 0.1 to 3 wt. % of the anionic surfactant C.3 which is a tristyrylphenol ethoxylate sulfate ammonium salt and the amounts given in wt. % are each based on the total weight of the formulation.

In another preferred embodiment, the oil-in-water emulsion formulation of this invention comprises
a) a discontinuous oil phase comprising 10 to 70 wt. % of a herbicide A selected from chloroacetamide herbicides and 1 to 30 wt. % of a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water,
c) 1 to 20 wt. % of a surfactant mixture C comprising at least two nonionic surfactants C.1 and C.2 and at least one anionic surfactant C.3,
d) 0.01 to 10 wt. % of a stabilizer D,
e) optionally 0.1 to 20 wt. % of an adjuvant E, and
f) 1 to 40 wt. % of auxiliaries F,
   wherein the solvent mixture S comprises a non-polar solvent S1 selected from aromatic hydrocarbons and a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate and the amounts given in wt. % are each based on the total weight of the formulation.

In another preferred embodiment, the oil-in-water emulsion formulation of this invention comprises
a) a discontinuous oil phase comprising 10 to 70 wt. % of a herbicide A selected from chloroacetamide herbicides and 1 to 30 wt. % of a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water,
c) 1 to 20 wt. % of a surfactant mixture C comprising at least two nonionic surfactants C.1 and C.2 and at least one anionic surfactant C.3,
d) 0.1 to 5 wt. % of a stabilizer D selected from vinylpyrrolidone-vinyl acetate copolymers, microcrystalline cellulose, and any combination thereof,
e) optionally 0.5 to 15 wt. % of an adjuvant E selected from polyoxyalkylene sorbitan fatty acid esters, preferably from polyoxyethylene sorbitan fatty acid esters, and
f) 1 to 40 wt. % of auxiliaries F selected from antifreeze agents, anti-foaming agents, preservatives, and any combination thereof,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16 and the amounts given in wt. % are each based on the total weight of the formulation.

In another preferred embodiment, the oil-in-water emulsion formulation of this invention comprises
a) a discontinuous oil phase comprising 10 to 70 wt. % of a herbicide A selected from chloroacetamide herbicides and a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water,
c) a surfactant mixture C comprising at least two nonionic surfactants C.1 and C.2 and at least one anionic surfactant C.3,
d) 0.1 to 5 wt. % of a stabilizer D selected from vinylpyrrolidone-vinyl acetate copolymers, microcrystalline cellulose, and any combination thereof,
e) optionally 0.5 to 15 wt. % of an adjuvant E selected from polyoxyalkylene sorbitan fatty acid esters, preferably from polyoxyethylene sorbitan fatty acid esters, and
f) 5 to 25 wt. % of auxiliaries F selected from antifreeze agents, anti-foaming agents, preservatives, and any combination thereof,
   wherein the solvent mixture S comprises 3 to 25 wt. %, preferably 4 to 15 wt. %, more preferably 4 to 10 wt. % of the non-polar solvent S1 selected from aromatic hydrocarbons and 1 to 10 wt. %, preferably 2.5 to 8 wt. %, more preferably 4 to 7 wt. % of the solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.1 to 10 wt. % of the nonionic surfactant C.1 selected from polyalkoxylated alkyl ethers, 0.1 to 10 wt. % of the nonionic surfactant C.2 selected from C₁₀-C₁₄-alcohol polyglycol ethers and 0.05 to 5 wt. % of the anionic surfactant C.3 selected from polyarylphenol polyalkoxy ether sulfates and the amounts given in wt. % are each based on the total weight of the formulation.

In another preferred embodiment, the oil-in-water emulsion formulation of this invention comprises
a) a discontinuous oil phase comprising 10 to 70 wt. % of a herbicide A selected from chloroacetamide herbicides and a solvent mixture S comprising a non-polar solvent S1 and a solvent S2 having a higher polarity than the non-polar solvent S1,
b) a continuous aqueous phase comprising 0.01 to 10 wt. % of a herbicide B which is a water-soluble salt of a pyridinecarboxylic acid herbicide and 1 to 40 wt. % of water,
c) a surfactant mixture C comprising at least two nonionic surfactants C.1 and C.2 and at least one anionic surfactant C.3,
d) 0.5 to 3 wt. % of a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose,
e) optionally 1 to 10 wt. % of an adjuvant E which is polyoxyethylene sorbitan monolaurate, preferably polyoxyethylene (20) sorbitan monolaurate, and
f) 5 to 25 wt. % of auxiliaries F selected from antifreeze agents, anti-foaming agents, preservatives, and any combination thereof,
   wherein the solvent mixture S comprises 3 to 25 wt. %, preferably 4 to 15 wt. %, more preferably 4 to 10 wt. % of a non-polar solvent S1 selected from aromatic hydrocarbons and 1 to 10 wt. %, preferably 2.5 to 8 wt. %, more preferably 4 to 7 wt. % of a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.5 to 5 wt. % of the nonionic surfactant C.1 which is a polyoxyalkalyted butyl ether, 0.5 to 5 wt. % of the nonionic surfactant C.2 which is an iso-tridecyl alcohol polyglycol ether and 0.1 to 3 wt. % of the anionic surfactant C.3 which is a tristyrylphenol ethoxylate sulfate ammonium salt and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water,
c) 1 to 20 wt. % of a surfactant mixture C comprising at least two nonionic surfactants C.1 and C.2 and at least one anionic surfactant C.3,
d) 0.01 to 10 wt. % of a stabilizer D,
e) optionally 0.1 to 20 wt. % of an adjuvant E, and
f) 1 to 40 wt. % of auxiliaries F,
   wherein the solvent mixture S comprises a non-polar solvent S1 selected from aromatic hydrocarbons and a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water,
c) 1 to 20 wt. % of a surfactant mixture C comprising at least two nonionic surfactants C.1 and C.2 and at least one anionic surfactant C.3,
d) 0.1 to 5 wt. % of a stabilizer D selected from vinylpyrrolidone-vinyl acetate copolymers, microcrystalline cellulose, and any combination thereof,
e) optionally 0.5 to 15 wt. % of an adjuvant E selected from polyoxyalkylene sorbitan fatty acid esters, preferably from polyoxyethylene sorbitan fatty acid esters, and
f) 1 to 40 wt. % of auxiliaries F selected from antifreeze agents, anti-foaming agents, preservatives, and any combination thereof,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16 and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water,
c) a surfactant mixture C comprising at least two nonionic surfactants C.1 and C.2 and at least one anionic surfactant C.3,
d) 0.1 to 5 wt. % of a stabilizer D selected from vinylpyrrolidone-vinyl acetate copolymers, microcrystalline cellulose, and any combination thereof,
e) optionally 0.5 to 15 wt. % of an adjuvant E selected from polyoxyalkylene sorbitan fatty acid esters, preferably from polyoxyethylene sorbitan fatty acid esters, and
f) 5 to 25 wt. % of auxiliaries F selected from antifreeze agents, anti-foaming agents, preservatives, and any combination thereof,
   wherein the solvent mixture S comprises 3 to 25 wt. %, preferably 4 to 15 wt. %, more preferably 4 to 10 wt. % of the non-polar solvent S1 selected from aromatic hydrocarbons and 1 to 10 wt. %, preferably 2.5 to 8 wt. %, more preferably 4 to 7 wt. % of the solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.1 to 10 wt. % of the nonionic surfactant C.1 selected from polyalkoxylated alkyl ethers, 0.1 to 10 wt. % of the nonionic surfactant C.2 selected from C₁₀-C₁₄-alcohol polyglycol ethers and 0.05 to 5 wt. % of the anionic surfactant C.3 selected from polyarylphenol polyalkoxy ether sulfates and the amounts given in wt. % are each based on the total weight of the formulation.

In another preferred embodiment, the oil-in-water emulsion formulation of this invention comprises
a) a discontinuous oil phase comprising 30 to 60 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.05 to 5 wt. % of a herbicide B which is a water-soluble salt of aminopyralid and 1 to 40 wt. % of water,
c) a surfactant mixture C comprising at least two nonionic surfactants C.1 and C.2 and at least one anionic surfactant C.3,
d) 0.5 to 3 wt. % of a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose,
e) optionally 1 to 10 wt. % of an adjuvant E which is polyoxyethylene sorbitan monolaurate, preferably polyoxyethylene (20) sorbitan monolaurate, and
f) 5 to 25 wt. % of auxiliaries F selected from antifreeze agents, anti-foaming agents, preservatives, and any combination thereof,
   wherein the solvent mixture S comprises 3 to 25 wt. %, preferably 4 to 15 wt. %, more preferably 4 to 10 wt. % of a non-polar solvent S1 selected from aromatic hydrocarbons and 1 to 10 wt. %, preferably 2.5 to 8 wt. %, more preferably 4 to 7 wt. % of a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.5 to 5 wt. % of the nonionic surfactant C.1 which is a polyoxyalkalyted butyl ether, 0.5 to 5 wt. % of the nonionic surfactant C.2 which is an iso-tridecyl alcohol polyglycol ether and 0.1 to 3 wt. % of the anionic surfactant C.3 which is a tristyrylphenol ethoxylate sulfate ammonium salt and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water,
c) 1 to 20 wt. % of a surfactant mixture C comprising at least two nonionic surfactants C.1 and C.2 and at least one anionic surfactant C.3,
d) 0.01 to 10 wt. % of a stabilizer D,
e) optionally 0.1 to 20 wt. % of an adjuvant E, and
f) 1 to 40 wt. % of auxiliaries F,
   wherein the solvent mixture S comprises a non-polar solvent S1 selected from aromatic hydrocarbons and a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and 1 to 30 wt. % of a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water,
c) 1 to 20 wt. % of a surfactant mixture C comprising at least two nonionic surfactants C.1 and C.2 and at least one anionic surfactant C.3,
d) 0.1 to 5 wt. % of a stabilizer D selected from vinylpyrrolidone-vinyl acetate copolymers, microcrystalline cellulose, and any combination thereof,
e) optionally 0.5 to 15 wt. % of an adjuvant E selected from polyoxyalkylene sorbitan fatty acid esters, preferably from polyoxyethylene sorbitan fatty acid esters, and
f) 1 to 40 wt. % of auxiliaries F selected from antifreeze agents, anti-foaming agents, preservatives, and any combination thereof,
   wherein the non-polar solvent S1 is selected from aromatic hydrocarbons, the solvent S2 is selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the nonionic surfactant C.1 has a HLB ranging from 8 to 12, preferably 10 to 12, and the nonionic surfactant C.2 has a HLB ranging from 12 to 18, preferably 12 to 16 and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water,
c) a surfactant mixture C comprising at least two nonionic surfactants C.1 and C.2 and at least one anionic surfactant C.3,
d) 0.1 to 5 wt. % of a stabilizer D selected from vinylpyrrolidone-vinyl acetate copolymers, microcrystalline cellulose, and any combination thereof,
e) optionally 0.5 to 15 wt. % of an adjuvant E selected from polyoxyalkylene sorbitan fatty acid esters, preferably from polyoxyethylene sorbitan fatty acid esters, and
f) 5 to 25 wt. % of auxiliaries F selected from antifreeze agents, anti-foaming agents, preservatives, and any combination thereof,
   wherein the solvent mixture S comprises 3 to 25 wt. %, preferably 4 to 15 wt. %, more preferably 4 to 10 wt. % of the non-polar solvent S1 selected from aromatic hydrocarbons and 1 to 10 wt. %, preferably 2.5 to 8 wt. %, more preferably 4 to 7 wt. % of the solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.1 to 10 wt. % of the nonionic surfactant C.1 selected from polyalkoxylated alkyl ethers, 0.1 to 10 wt. % of the nonionic surfactant C.2 selected from C₁₀-C₁₄-alcohol polyglycol ethers and 0.05 to 5 wt. % of the anionic surfactant C.3 selected from polyarylphenol polyalkoxy ether sulfates and the amounts given in wt. % are each based on the total weight of the formulation.

In another preferred embodiment, the oil-in-water emulsion formulation of this invention comprises
a) a discontinuous oil phase comprising 40 to 50 wt. % of a herbicide A which is dimethenamid-P and a solvent mixture S comprising a non-polar solvent S1 and a solvent S2 having a higher polarity than the non-polar solvent S1,
b) a continuous aqueous phase comprising 0.1 to 2.5 wt. % of a herbicide B which is aminopyralid-potassium and 1 to 40 wt. % of water,
c) a surfactant mixture C comprising at least two nonionic surfactants C.1 and C.2 and at least one anionic surfactant C.3,
d) 0.5 to 3 wt. % of a stabilizer D comprising a vinylpyrrolidone/vinyl acetate copolymer having a ratio of vinylpyrrolidone (VP) to vinyl acetate (VA) of 50:70 to 30:50, preferably 60:40, and water-dispersible microcrystalline cellulose,
e) optionally 1 to 10 wt. % of an adjuvant E which is polyoxyethylene sorbitan monolaurate, preferably polyoxyethylene (20) sorbitan monolaurate, and
f) 5 to 25 wt. % of auxiliaries F selected from antifreeze agents, anti-foaming agents, preservatives, and any combination thereof,
   wherein the solvent mixture S comprises 3 to 25 wt. %, preferably 4 to 15 wt. %, more preferably 4 to 10 wt. % of a non-polar solvent S1 selected from aromatic hydrocarbons and 1 to 10 wt. %, preferably 2.5 to 8 wt. %, more preferably 4 to 7 wt. % of a solvent S2 selected from 2,2,4-trimethyl-1,3-pentanediol monoisobutyrate, N,N-dimethyl(C₂-C₂₀)hydroxyalkylamides or a combination thereof, preferably selected from 2,2,4-trimethyl-1,3-pentanediol monoisobutyrate, N,N-dimethyllactamide or a combination thereof and is in particular 2,2,4-trimethyl-1,3-pentanediol monoisobutyrate, the surfactant mixture C comprises 0.5 to 5 wt. % of the nonionic surfactant C.1 which is a polyoxyalkalyted butyl ether, 0.5 to 5 wt. % of the nonionic surfactant C.2 which is an iso-tridecyl alcohol polyglycol ether and 0.1 to 3 wt. % of the anionic surfactant C.3 which is a tristyrylphenol ethoxylate sulfate ammonium salt and the amounts given in wt. % are each based on the total weight of the formulation.

The present invention also relates to a process for preparing the oil-in-water emulsion formulation as described herein comprising the steps of
a) mixing water, the pyridinecarboxylic acid herbicide in its acid form and a base to form an aqueous solution of the water-soluble salt of the pyridinecarboxylic acid herbicide (herbicide B),
b) adding the stabilizer D and optionally hydrophilic auxiliaries F to the aqueous solution obtained in step a) to form an aqueous phase,
c) preparing an oil phase comprising the herbicide A, the solvent mixture S, the surfactant mixture C and optionally lipophilic auxiliaries F, and
d) mixing the oil phase obtained in step c) with the aqueous phase obtained in step b) under stirring and subsequent high shear homogenization to obtain the oil-in-water emulsion formulation.

The process according to this invention optionally comprises an additional step e) of adding the adjuvant E to the oil-in-water emulsion formulation obtained in step d) under stirring and subsequent high shear homogenization.

In the process of this invention, the order of addition of the various ingredients used in both the oil and aqueous phase is of minor importance. This also applies to the order of combining the oil phase with the aqueous phase. Some of the optional auxiliaries F may even be added after the mixing of the oil and aqueous phase. A variety of known apparatus may be used to accomplish the mixing steps. In either of the above steps, heat and/or agitation may be applied to ease the formation of a homogeneous phase.

In step a), water, the pyridinecarboxylic acid herbicide in its acid form and a base are mixed to form an aqueous solution of the water-soluble salt of the pyridinecarboxylic acid herbicide (herbicide B) as described hereinabove. The term “pyridinecarboxylic acid herbicide in its acid form” as used herein means that the pyridine pyridinecarboxylic acid herbicide is provided in its acid form, i.e., as the mere carboxylic acid. Preferably, the pyridinecarboxylic acid herbicide in its acid form is selected from aminopyralid, clopyralid, florpyrauxifen, halauxifen and picloram. More preferably, the pyridinecarboxylic acid herbicide in its acid form is aminopyralid. The base is preferably selected from a metal hydroxide, ammonia, an amine and a tetraalkylammonium hydroxide. Suitable examples of metal hydroxides include sodium hydroxide or potassium hydroxide. Suitable examples of amines include trimethylamine, diethanolamine, triisopropanolamine, 2-methylthiopropylamine, bisallylamine, 2-butoxyethylamine, morpholine, cyclododecylamine, or benzylamine. Suitable examples of tetraalkylammonium hydroxides include tetramethylammonium hydroxide or choline hydroxide. In a preferred embodiment, the base is selected from a metal hydroxide, more preferably from sodium hydroxide, potassium hydroxide or a combination thereof. In particular, the base is potassium hydroxide. In an especially preferred embodiment of step a), water, aminopyralid and potassium hydroxide are mixed to form an aqueous solution of aminopyralid-potassium (herbicide B). Alternatively, it is also possible to mix water with a pre-formed water-soluble salt of the pyridinecarboxylic acid herbicide (herbicide B). For example, water can also be mixed with pre-formed aminopyralid-potassium.

In step b), water, the stabilizer D and optionally hydrophilic auxiliaries F as described hereinabove are added to the aqueous solution obtained in step a) to form an aqueous phase. Optional hydrophilic auxiliaries F include, for example, antifreeze agents, anti-foaming agents, preservatives and colorants.

In step c), an oil phase comprising the herbicide A, the solvent mixture S (i.e., the non-polar solvent S1 and the solvent S2), the surfactant mixture C (i.e., the nonionic surfactants C.1 and C.2 and the anionic surfactant C.3) and optionally lipophilic auxiliaries F is prepared. Optional lipophilic auxiliaries F include, for example, anti-foaming agents, colorants and UV absorbers. Usually, the oil phase is prepared by first mixing the herbicide A with the solvent mixture S (i.e., the non-polar solvent S1 and the solvent S2) and then adding the surfactant mixture C (i.e., the nonionic surfactants C.1 and C.2 and the anionic surfactant C.3) and the optional lipophilic auxiliaries F to the resulting mixture.

In step d), the oil phase obtained in step c) is mixed with the aqueous phase obtained in step b) under stirring and subsequent high shear homogenization to obtain the oil-in-water emulsion formulation of the present invention. The two phases are conventionally mixed. The mixing of step d) is preferably accomplished by supplying energy into the mixture of the phases by means of shaking, beating, stirring, turbulent mixing (for example rotor-stator mixer); by injecting one fluid into another; by oscillations and cavitation in the mixture (for example ultrasound); by means of emulsifying centrifuges; by means of colloid mills and homogenizers; or by means of a jet nozzle. Mixing usually takes place at from 5 to 90 °C, preferably at from 10 to 50 °C. Usually, the mixing of the two phases under the subsequent high shear homogenization is continued until the desired D₅₀ of the oil phase droplets in the emulsion as defined hereinabove is achieved.

The present invention also relates to the use of the oil-in-water emulsion formulation as described herein for controlling undesirable vegetation, and to a method for controlling undesirable vegetation comprising applying the oil-in-water emulsion formulation as described herein to the vegetation or the locus thereof.

The oil-in-water emulsion formulation of the present invention is suitable for controlling a large number of undesirable vegetation (harmful plants), including monocotyledonous weeds and dicotyledonous weeds.

In particular, the oil-in-water emulsion formulation of the present invention may be used for controlling annual weeds such as gramineous weeds (grass weeds) including, but not limited to, the genera Aegilops such as Aegilops cylindrical (AEGCY, jointed goatgrass); Agropyron such as Agropyron repens (AGRRE, common couchgrass); Alopecurus such as Alopecurus myosuroides (ALOMY, blackgrass) or Alopecurus aequalis (ALOAE, foxtail); Apera such as Apera spica-venti (APESV, silky wind grass); Avena such as Avena fatua (AVEFA, wild oat) or Avena sterilis subsp. Sterilis (AVEST, sterile oat); Brachiaria such as Brachiaria plantaginea (BRAPL, Alexander grass) or Brachiaria decumbens (BRADC, Surinam grass); Bromus such as Bromus inermis (BROIN, awnless brome), Bromus sterilis (BROST, barren bromegrass), Bromus tectorum (BROTE, cheatgrass), Bromus arvensis (BROAV, field bromegrass), Bromus secalinus (BROSE, rye bromegrass) or Bromus hordeacus (BROMO, lopgrass); Cenchrus such as Cenchrus echinatus (CCHEC, Mossman River grass); Cynodon such as Cynodon dactylon (CYNDA, bermudagrass); Digitaria such as Digitaria ciliaris (DIGAD, southern crabgrass), Digitaria sanguinalis (DIGSA, hairy crabgrass), Digitaria insularis (TRCIN, sourgrass) or Digitaria ischaemum (DIGIS, smooth crabgrass); Echinochloa such as Echinochloa colonum (ECHCO, awnless barnyardgrass), Echinochloa crus-galli (ECHCG, common barnyard grass), Echinochloa crus-pavonis (ECHCV, Gulf cockspurgrass), Echinochloa oryzoides (ECHOR, early barnyardgrass) or Echinochloa phyllogogon (ECHPH, late barnyardgrass); Eleusine such as Eleusine indica (ELEIN, Indian goosegrass); Eriochloa species such as Eriochloa villosa, Ischaemum such as Ischaemum rugusom (ISCRU, muraina grass); Leptochloa such as Leptochloa chinensis (LEFCH, Chinese sprangletop), Leptochloa fascicularis (LEFFA, salt-meadow grass), Leptochloa filiformis (LEFPC, thread sprangletop), Leptochloa mucronata (LEFFI, red sprangletop), Leptochloa panicoides (LEFPA, tighthead sprangletop), Leptochloa scabra (LEFSC) or Leptochloa virgata (LEFVI, tropical sprangletop); Lolium such as Lolium multiflorum (LOLMU, Italian ryegrass), Lolium perenne (LOLPE, English ryegrass) or Lolium rigidum (LOLRI, annual rye-grass); Panicum such as Panicum capillare (PANCA, tumble panicgrass), Panicum dichotomiflorum (PANDI, smooth witchgrass), Panicum laevifolium (PANLF, sweet panicgrass) or Panicum miliaceum (PANMI, common millet); Phalaris such as Phalaris minor (PHAMI, lesser canary grass), Phalaris paradoxa (PHAPA, paradoxagrass), Phalaris canariensis (PHACA, canarygrass) or Phalaris brachystachys (PHABR, shortspiked canarygrass); Poa such as Poa annua (POAAN, annual bluegrass), Poa pratensis (POAPR, Kentucky bluegrass) or Poa trivialis (POATR, rough meadowgrass); Rottboellia such as Rottboellia exaltata (ROOEX, guinea-fowl grass); Setaria auch as Setaria faberi (SETFA, giant foxtail), Setaria glauca (PESGL, pearl millet), Setaria italic (SETIT, Italian millet), Setaria pumila (SETPU, yellow foxtail), Setaria verticillate (SETVE, bristly foxtail) or Setaria viridis (SETVI, green foxtail); and Sorghum such as Sorghum halepense (SORHA, Johnson grass).

The oil-in-water emulsion formulation of the present invention is also suitable for controlling a large number of dicotyledonous weeds, in particular broadleaf weeds including, but not limited to, Polygonum species such as Polygonum convolvolus (POLCO, wild buckwheat), Amaranthus species such as Amaranthus albus (AMAAL, tumble pigweed), Amaranthus blitoides (AMABL, mat amaranth), Amaranthus hybridus (AMACH, green pigweed), Amaranthus palmeri (AMAPA, Palmer amaranth), Amaranthus powellii (AMAPO, Powell amaranth), Amaranthus retroflexus (AMARE, redroot pigweed), Amaranthus tuberculatus (AMATU, rough-fruit amaranth), Amaranthus rudis (AMATA, tall amaranth) or Amaranthus viridis (AMAVI, slender amaranth), Chenopodium species such as Chenopodium album (CHEAL, common lambsquarters), Chenopodium ficifolium (CHEFI, fig-leaved goosefoot), Chenopodium polyspermum (CHEPO, manyseeded goosefoot) or Chenopodium hybridum (CHEHY, maple-leaf goosefoot), Sida species such as Sida spinosa L. (SIDSP, prickly sida), Ambrosia species such as Ambrosia artemisiifolia (AMBEL, common ragweed), Acanthospermum species, Anthemis species such as Anthemis arvensis (ANTAR, field chamomile), Atriplex species, Cirsium species, Convolvulus species, Conyza species such as Conyza bonariensis (ERIBO, hairy horseweed) or Conyza canadensis (ERICA, Canada horseweed), Cassia species, Commelina species, Datura species, Euphorbia species, Geranium species such as Geranium dissectum (GERDI, cut-leaf geranium), Geranium pusillium (GERPU, small-flower geranium) or Geranium rotundifolium (GERRT, roundleaved cranesbill), Galinsoga species, Ipomoea species such as Ipomoea hederacea (IPOHE, morningglory), Lamium species such as Lamium amplexicaule (LAMAM) or Lamium purpureum (LAMPU), Malva species, Matricaria species such as Matricaria chamomilla (MATCH, wild chamomile) or Matricaria discoidea (MATMT, pineapple weed), Tripleurospermum species such as Tripleurospermum inodorum (MATIN, false chamomille), Solanum species, Xanthium species, Veronica species such as Veronica hederifolia (VERHE) or Veronica persica (VERPE), Viola species such as Viola arvensis (VIOAR), Stellaria species such as Stellaria media (STEME, common chickweed), Abutilon theophrasti (ABUTH, velvet leaf), Hemp sesbania (Sesbania exaltata Cory, SEBEX, Colorado river hemp), Anoda cristata (ANVCR, cottonweed), Bidens pilosa (BIDPI, common blackjack), Centaurea species such as Centaurea cyanus (CENCY, cornflower), Galeopsis tetrahit (GAETE common hemp nettle), Galium aparine (GALAP, cleavers or goosegrass), Galium spurium (GALSP, false cleavers), Galium tricornutum (GALTC, corn cleavers), Helianthus annuus (HELAN, common sunflower), Desmodium tortuosum (DEDTO, giant beggar weed), Kochia scoparia (KCHSC, mock cypress), Mercurialis annua (MERAN, annual mercury), Myosotis arvensis (MYOAR, field forget-me-not), Papaver rhoeas (PAPRH, common poppy), Raphanus raphanistrum, Salsola kali (SASKA, prickly glasswort), Sonchus arvensis (SONAR, corn sowthistle), Tagetes minuta (TAGMI, Mexican marigold), Richardia brasiliensis (RCHBR, Brazil pusley), cruciferous weeds such as Raphanus raphanistrum (RAPRA, wild radish), Sinapis alba (SINAL, white mustard), Sinapis arvensis (SINAR, wild mustard), Thlaspi arvense (THLAR, fanweed), Descurainia Sophia (DESSO, flixweed), Capsella bursa-pastoris (CAPBP, shepherd's purse), Sisymbrium species such as Sisymbrium officinale (SSYOF, hedge mustard) or Sisymbrium orientale (SSYOR, oriental mustard), Brassica kaber (SINAR, wild mustard).

The oil-in-water emulsion formulation of the present invention is also suitable for controlling a large number of annual and perennial sedge weeds including Cyperus species such as purple nutsedge (Cyperus rotundus L.), yellow nutsedge (Cyperus esculentus L.), hime-kugu (Cyperus brevifolius H.), sedge weed (Cyperus microiria Steud), rice flatsedge (Cyperus iria L.), and the like.

In a preferred embodiment, the undesirable vegetation is selected from the genera Aethusa, Anthemis, Apera, Capsella, Centaurea, Chenopodium, Consolida, Daucus, Descurainia, Euphorbia, Galium, Geranium, Lamium, Matricaria, Papaver, Polygonum, Sisymbrium, Stellaria, Thlaspi, Tripleurospermum, Veronica and Viola, more preferably selected from the genera Anthemis, Apera, Capsella, Centaurea, Chenopodium, Daucus, Geranium, Lamium, Matricaria, Papaver, Polygonum, Sysimbrium, Stellaria, Tripleurospermum, Veronica and Viola, and yet more preferably selected from the genera Anthemis, Apera, Capsella, Centaurea, Chenopodium, Geranium, Lamium, Matricaria, Papaver, Stellaria, Tripleurospermum, Veronica and Viola.

In a particularly preferred embodiment, the undesirable vegetation is selected from the weed species Aethusa cynapium (AETCY), Aethusa sp. (AETSS), Anthemis arvensis (ANTAR), Apera spica-venti (APESV), Capsella bursa-pastoris (CAPBP), Centaurea cyanus (CENCY), Chenopodium album (CHEAL), Consolida regalis (CNSRE), Daucus carota (DAUCA), Descurainia sophia (DESSO), Euphorbia helioscopia (EPHHE), Galium aparine (GALAP), Geranium dissectum (GERDI), Geranium pusillium (GERPU), Geranium rotundifolium (GERRT), Geranium sp. (GERSS), Lamium amplexicaule (LAMAM), Lamium purpureum (LAMPU), Matricaria chamomilla (MATCH), Papaver rhoeas (PAPRH), Polygonum convolvulus (POLCO), Sisymbrium officinale (SSYOF), Stellaria media (STEME), Thlaspi arvense (THLAR), Tripleurospermum inodorum (MATIN), Veronica hederifolia (VERHE), Veronica persica (VERPE) and Viola arvensis (VIOAR), especially preferably selected from the weed species Anthemis arvensis (ANTAR), Apera spica-venti (APESV), Capsella bursa-pastoris (CAPBP), Centaurea cyanus (CENCY), Chenopodium album (CHEAL), Daucus carota (DAUCA), Geranium dissectum (GERDI), Geranium rotundifolium (GERRT), Lamium amplexicaule (LAMAM), Lamium purpureum (LAMPU), Matricaria chamomilla (MATCH), Papaver rhoeas (PAPRH), Polygonum convolvulus (POLCO), Sysimbrium officinale (SSYOF), Stellaria media (STEME), Tripleurospermum inodorum (MATIN), Veronica hederifolia (VERHE), Veronica persica (VERPE) and Viola arvensis (VIOAR) and in particular selected from the weed species Anthemis arvensis (ANTAR), Apera spica-venti (APESV), Capsella bursa-pastoris (CAPBP), Centaurea cyanus (CENCY), Chenopodium album (CHEAL), Geranium dissectum (GERDI), Geranium rotundifolium (GERRT), Lamium amplexicaule (LAMAM), Lamium purpureum (LAMPU), Matricaria chamomilla (MATCH), Papaver rhoeas (PAPRH), Stellaria media (STEME), Tripleurospermum inodorum (MATIN), Veronica hederifolia (VERHE), Veronica persica (VERPE) and Viola arvensis (VIOAR).

Another aspect of the present invention is the use of the oil-in-water emulsion formulation according to the invention in agrochemical applications (e.g. crop protection, agricultural non-crop applications, seed treatment), pharmaceutical applications, personal care applications (e.g. cosmetic applications), textile applications, human or animal nutrition applications, chemical process applications, adhesives and sealants, paints and coatings, building and construction materials, self-healing materials, tobacco industry, household applications.

In one embodiment, the oil-in-water emulsion formulation according to the invention is used in crop protection.

The oil-in-water emulsion formulation according to the invention is particularly important in the control of a multitude of undesirable vegetation on various cultivated plants, such as cereals, e.g. wheat, rye, barley, triticale, oats or rice; beet, e. g. sugar beet or fodder beet; fruits, such as pomes, stone fruits or soft fruits, e. g. apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (Table grapes and grape juice grape vines); hop; turf; sweet leaf (also called Stevia); natural rubber plants or ornamental and forestry plants, such as flowers, shrubs, broad-leaved trees or evergreens, e. g. conifers; and on the plant propagation material, such as seeds, and the crop material of these plants.

Preferred crops are Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays.

More preferably, the crop plants are selected from cereals, corn, soybeans, rice, Brassica crops, cotton, potatoes, peanuts or permanent crops.

Especially preferred crops are crops of cereals, corn, soybeans, rice, oilseed rape, canola, cotton, potatoes, peanuts or permanent crops.

In a particularly preferred embodiment, the undesirable vegetation is controlled in Brassica crops, in particular oilseed rape.

According to the invention all the crop plants (cultivated plants) mentioned herein are understood to comprise all species, subspecies, variants and/or hybrids which belong to the respective cultivated plants, including but not limited to winter and spring varieties, in particular in cereals such as wheat and barley, as well as oilseed rape, e.g. winter wheat, spring wheat, winter barley, winter oilseed rape and spring oilseed rape.

The term “Brassica crops” as used herein includes, but is not limited to, all varieties of canola and oilseed rape (Brassica napus, BRSNN), forage brassica, garden brassica and seed producing brassica, including spring rape or Spring Argentine canola (Brassica napus, BRSNS), winter oilseed rape (Brassica napus, BRSNW), Roundup Ready® canola (Brassica napus, RRBRSNN), Nexera™ canola (Brassica napus, BRSNN-NEX), stem kale (Brassica oleracea var. acephala subvar. medullosa, BRSOM), Aparima Gold swede (Brassica sp., BRSSS), rutabaga (Brassica napus var. napobrassica, BRSNA), turnip or Polish canola (Brassica rapa, BRSRR), kale/Chinese kale (Brassica alboglabra, BRSAG), Juncea canola or brown mustard (Brassica juncea, BRSJU), broccoli/cauliflower (Brassica oleracea [botrytis], BRSOK), cabbage (Brassica oleracea [capitata], BRSOL), Abyssinian mustard (Brassica carinata, BRSCA), yellow mustard (Sinapis alba, SINAL) and Gold-of-Pleasure (Camelina sativa, CMASA).

The term “crop plants” also includes those plants which have been modified by breeding, mutagenesis or methods, including the biotechnological agricultural products which are on the market or in the process of being developed. Genetically modified plants are plants whose genetic material has been modified in a manner which does not occur under natural conditions by hybridizing, mutations or natural recombination (i.e. recombination of the genetic material). Here, one or more genes will, as a rule, be integrated into the genetic material of the plant in order to improve the properties of the plants. Such recombinant modifications also comprise posttranslational modifications of proteins, oligo- or polypeptides, for example by means of glycosylation or binding polymers such as, for example, prenylated, acetylated or farnesylated residues or PEG residues.

When used in crop protection, the oil-in-water emulsion formulation according to the invention may be applied as such or is preferably applied after dilution with water. Preferably, for various purposes of end user application, a so-called aqueous spray-liquor is prepared by diluting the oil-in-water emulsion formulation of the present invention with water. The spray-liquors may also comprise further constituents in dissolved, emulsified or suspended form, for example fertilizers, active substances of other groups of herbicidal or growth-regulatory active substances, further active substances, for example active substances for controlling animal pests or phytopathogenic fungi or bacteria, furthermore mineral salts which are employed for alleviating nutritional and trace element deficiencies, and non-phytotoxic oils or oil concentrates. These agents can be admixed with the oil-in-water emulsion formulation according to the invention in a weight ratio of 1:100 to 100:1, preferably 1:10 to 10:1. As a rule, these constituents are added to the spray mixture before, during or after dilution of the oil-in-water emulsion formulation according to the invention. The oil-in-water emulsion formulation of this invention is usually applied from a pre-dosage device, a knapsack sprayer, a spray tank, a spray plane, or an irrigation system. Usually, 20 to 2000 liters, preferably 50 to 400 liters, of the ready-to-use spray liquor are applied per hectare of agricultural useful area.

The oil-in-water emulsion formulation of the invention can be applied by the pre-emergence or the postemergence method. If one of the active compounds is less well tolerated by certain crop plants, application techniques may be employed where the oil-in-water emulsion formulation of this invention is sprayed, with the aid of the spraying apparatus, in such a way that the leaves of the sensitive crop plants ideally do not come into contact with them, while the active substances reach the leaves of undesired plants which grow underneath, or the bare soil surface (post-directed, lay-by).

Various types of oils, wetting agents, adjuvants, fertilizer, or micronutrients, and further pesticides (e.g., herbicides, insecticides, fungicides, growth regulators, safeners) may be added to the compositions comprising them as premix or, if appropriate not until immediately prior to use (tank mix). These agents can be admixed with the oil-in-water emulsion formulation according to the invention in a weight ratio of 1:100 to 100:1, preferably 1:10 to 10:1.

The oil-in-water emulsion formulation of the invention is generally applied in such amounts that the amounts of the herbicides A and B applied are, depending on the kind of effect desired, from 0.001 to 2 kg per ha (hectare), preferably from 0.005 to 2 kg per ha, more preferably from 0.05 to 0.9 kg per ha, in particular from 0.05 to 0.6 kg per ha.

The present invention provides various advantages:

The oil-in-water emulsion formulation of this invention has a high physical and/or chemical stability, thus increasing the shelf life of the formulation, which is of relevance for storage and/or facing difficult climate conditions. In particular, no or only little phase separation which is easily re-dispersible if required is observed during storage of the formulation. Further, the oil-in-water emulsion formulation of this invention has a particularly good physicochemical behavior at high and low temperatures.

The oil-in-water emulsion formulation of this invention enables the ready-mix of two herbicidal active ingredients with contrasting physicochemical properties, namely a water-insoluble chloroacetamide herbicide (preferably dimethenamid-P) and a water-soluble salt of a pyridinecarboxylic acid herbicide (preferably a water-soluble salt of aminopyralid, in particular aminopyralid-potassium).

The oil-in-water emulsion formulation of this invention allows for a high loading with the agrochemical active ingredients, which reduces costs for transportation and storage for the producer, distributor and farmer.

Moreover, the oil-in-water emulsion formulation of this invention permits the addition of large amounts of adjuvants. The good storage stability is retained even when such adjuvants are added.

A further advantage is that the oil-in-water emulsion formulation according to the invention shows a high biological activity for controlling undesirable vegetation, in particular in the control of weeds in Brassica crops, more specifically oilseed rape. In addition, the oil-in-water emulsion formulation according to this invention can be applied from pre- to post-emergence of the crop plants, especially oilseed rape, thus allowing a flexible application timing. Furthermore, the oil-in-water emulsion formulation according to this invention comprising a solvent mixture of a non-polar solvent S1 and a solvent S2 having a higher polarity than the non-polar solvent S1 (e.g., 2,2,4-trimethyl-1,3-pentanediol monoisobutyrate and N,N-dimethyllactamide) provides a significantly better post-emergence weed control, especially in oilseed rape, compared with a formulation comprising only said non-polar solvent S1 while not compromising on the crop safety.

Another advantage of the oil-in-water emulsion formulation of the invention is that only a low amount of organic solvents is required since the latter can in part be replaced by water. The high content of water or low content of organic solvents of the formulation of this invention is ecologically advantageous. Moreover, the water-based formulation of this invention can be repackaged more readily, and its handling is less risky for the distributor and the farmer since the flashpoint is markedly lower.

The oil-in-water emulsion formulation of the invention can be easily handled and applied by the users, especially the farmers, with the aid of the standard spraying equipment without blocking the filters of the application device.

The oil-in-water emulsion formulation of this invention is compatible and can be tank-mixed with a broad range of other active substances.

The examples which follow illustrate the invention without imposing any limitation.

### EXAMPLES

### I. Components of the Oil-In-Water Emulsion Formulation

TABLE 1
Components of the oil-in-water emulsion formulation of the invention

| Component* | Description |
|---|---|
| Herbicide A | Dimethenamid-P |
| Herbicide B | Aminopyralid-potassium |
| Non-polar solvent S1 | Aromatic hydrocarbon mixture, initial boiling point at |
| | 220 °C, final boiling point at 305 °C, maximum naphthalene |
| | content of 0.9 wt. % |
| Solvent S2a | 2,2,4-trimethyl-1,3-pentanediol monoisobutyrate |
| Solvent S2b | N,N-dimethyllactamide |
| Nonionic surfactant C.1 | Polyalkylene glycol butyl ether, the polyalkylene glycol |
| | unit being an ethylene oxide/propylene oxide block |
| | copolymer, OH number 17-26 mg KOH/g, HLB value 14, |
| | molar weight 5200 g/mol |
| Nonionic surfactant C.2 | Ethoxylated isotridecyl alcohol, degree of ethoxylation |
| | approximately 6 |
| Anionic surfactant C.3 | Tristyrylphenol (ethylene oxide)₁₆ sulfate ammonium salt |
| Stabilizer D.1 | Poly(vinylpyrrolidone co-vinyl acetate), having a ratio of |
| | vinylpyrrolidone (VP) to vinyl acetate (VA) in a weight |
| | ratio of 60:40 |
| Stabilizer D.2 | Microcrystalline cellulose powder with an average particle |
| | size of 20 μm |
| Adjuvant E | Polyoxyethylene (20) sorbitan monolaurate |
| Auxiliary F.1 | Glycerin (antifreeze agent) |
| Auxiliary F.2 | Polydimethylsiloxane-based antifoams |
| Auxiliary F.3 | Preservatives based on 5-chloro-2-methyl-4-isothiazolin- |
| | 3-one and/or 2-methyl-4-isothiazolin-3-one and/or 1,2- |
| | benzisothiazol-3(2H)-one |

*All components listed in Table 1 are commercially available

### II. Examples of the Oil-In-Water Emulsion Formulation According to the Invention

Table 2 below shows several examples of the oil-in-water emulsion formulation according to the invention (see formulations A to G).

TABLE 2
Formulation Examples A to G (amounts of components are given in % by weight)

| Component | A | B | C | D | E | F | G |
|---|---|---|---|---|---|---|---|
| Herbicide A | 45.05 | 44.25 | 44.64 | 44.64 | 44.25 | 44.25 | 44.64 |
| Herbicide B | 0.54* | 0.53* | 0.54* | 0.54* | 0.53* | 0.53* | 0.54* |
| | 0.64** | 0.63** | 0.63** | 0.63** | 0.63** | 0.63** | 0.63** |
| Non-polar | 4.5 | 6.64 | 4.46 | 4.46 | 6.64 | 4.42 | 4.46 |
| solvent S1 | | | | | | | |
| Solvent S2a | 4.5 | — | 4.46 | 4.46 | — | 4.42 | 4.46 |
| Solvent S2b | — | 6.64 | — | — | 6.64 | — | — |
| Nonionic | 1.58 | 1.55 | 1.56 | 1.56 | 1.55 | 1.55 | 1.56 |
| surfactant C.1 | | | | | | | |
| Nonionic | 1.58 | 1.55 | 1.56 | 1.56 | 1.55 | 1.55 | 1.56 |
| surfactant C.2 | | | | | | | |
| Anionic | 0.9 | 0.88 | 0.89 | 0.89 | 0.88 | 0.88 | 0.89 |
| surfactant C.3 | | | | | | | |
| Stabilizer D.1 | 1.8 | 1.77 | 1.79 | 1.79 | 1.77 | 1.77 | 0.89 |
| Stabilizer D.2 | 0.45 | 0.44 | 0.45 | 0.45 | 0.44 | 0.44 | 0.45 |
| Adjuvant E | — | — | 4.46 | — | — | 4.42 | 4.46 |
| Auxiliary F.1 | 11.26 | 11.06 | 11.16 | 11.16 | 11.06 | 11.06 | 11.16 |
| Auxiliary F.2 | 0.05 | 0.05 | 0.05 | 0.05 | 0.05 | 0.05 | 0.05 |
| Auxiliary F.3 | 0.18 | 0.18 | 0.18 | 0.27 | 0.27 | 0.27 | 0.27 |
| Water | 27.62 | 24.47 | 23.80 | 28.18 | 24.38 | 24.40 | 24.62 |

*amount of herbicide B calculated on an acid equivalent basis
**amount of herbicide B calculated as potassium salt

The formulations A to G were prepared by the following general procedure and using the amounts of the individual components as indicated in Table 2:

A solvent mixture consisting of solvents S1 and S2a (see formulations A, C, D, F and G) or of solvents S1 and S2b (see formulations B and E) was charged into a vessel equipped with a stirrer. Then dimethenamid-P (herbicide A) was added, and the mixture was stirred until it was homogenous. Then, the surfactants C.1, C.2 and C.3. were added and the mixture was stirred until a homogenous oil phase was obtained.

In a separate vessel, aminopyralid and potassium hydroxide were mixed with water, and the mixture was stirred until a homogenous aqueous solution of aminopyralid-potassium (herbicide B) was obtained. To this solution, the stabilizers D.1 and D.2, the auxiliaries F.1 (antifreeze agent), F.2 (anti-foaming agent) and F.3 (preservatives) were added, and the mixture was again stirred until a homogenous aqueous phase was obtained.

The aqueous phase was then stirred with a disperser by 300 rpm (round per minute). Then, the oil phase was added at room temperature to the stirred aqueous phase, and dispersing was continued for 15 minutes. The obtained mixture was sheared with a Siefer mill (rotor-stator-mill). This gave a white oil-in-water emulsion formulation with an average particle size (D₅₀) of approximately from 0.3 to 0.6 μm.

Optionally, the adjuvant E was added to the resulting oil-in-water emulsion under stirring with a disperser and the obtained mixture was then sheared with a Siefer mill (rotor stator mill) at room temperature (see formulations C, F and G). After the incorporation of the adjuvant E, the respective oil-in-water emulsion formulation had still a white colour a with an average particle size (D₅₀) of approximately from 0.4 to 1 μm.

### III. Storage Stability

The long-term stability of the oil-in-water emulsion formulation according to this invention was estimated by short-term storage at elevated temperature. For this purpose, samples of the oil-in-water emulsion formulations A to G were stored in tightly sealed glass containers for 2 weeks at 54 °C, and further samples for 8 weeks at 40 °C. The visual appearance, the particle size, the viscosity, the pH of the neat formulation and the active ingredient content were initially determined at room temperature directly after the preparation of the formulations and after the completion of the storage periods as given above.

Particle size distribution (PSD) was determined by statistic laser scattering according to ISO 13320, Particle Size Analysis—Laser Diffraction Methods, Dec. 1, 2009 using a Mastersizer 3000 manufactured by Malvern Instruments Ltd. A sample of the respective formulation was diluted in an excess of water and analyzed by laser diffraction. The data were treated by software using a “universal model” provided by Malvern Instruments. Important parameters are the D-values for n=50 and 90.

The viscosity of the respective formulations A to G were measured on a Discovery HR-10 viscosimeter at 20 °C.

The pH of the neat formulation was determined by a Knick Portamess pH meter.

The active ingredient content, i.e. the content of herbicides A and B, in the formulations A to G was determined in each case by means of quantitative HPLC.

TABLE 3
Physicochemical properties of Formulation Examples A to G

| | | | | | | | |
|---|---|---|---|---|---|---|---|
| Parameter | A | B | C | D | E | F | G |

Initial measurements at room temperature directly after preparation

| | | | | | | | |
|---|---|---|---|---|---|---|---|
| Visual | white | white | white | white | white | white | white |
| appearance | emulsion | emulsion | emulsion | emulsion | emulsion | emulsion | emulsion |
| D₅₀ (μm) | 0.50 | 0.49 | 0.35 | 0.5 | 0.6 | 0.4 | 0.42 |
| D₉₀ (μm) | 3.58 | 1.34 | 2.22 | 1.5 | 1.4 | 3.0 | 3.35 |
| Viscosity | 234 | 175 | 349 | 242 | 197 | 437 | 332 |
| (mPas) | | | | | | | |
| pH (neat | 5.01 | 5.04 | 4.94 | 6.1 | 6.0 | 5.9 | 5.7 |
| formulation) | | | | | | | |
| Content of | 503.03 | 511.09 | 506.51 | 502.7 | 506.5 | 498.8 | 497.62 |
| herbicide A | | | | | | | |
| (g/l) | | | | | | | |
| Content of | 5.98 | 5.75 | 5.83 | 6.49 | 6.53 | 6.44 | 5.86 |
| herbicide B* | | | | | | | |
| (g/l) | | | | | | | |

Measurements after storage for 2 weeks at 54 °C

| | | | | | | | |
|---|---|---|---|---|---|---|---|
| Visual | white | traces | traces | white | white | white | slight |
| appearance | emulsion | of | serum | emulsion | emulsion | emulsion | serum |
| | | serum | on top | | | | on top |
| D₅₀ (μm) | 0.90 | 0.94 | 1.23 | 1.1 | 0.8 | 1.0 | 1.08 |
| D₉₀ (μm) | 2.27 | 2.15 | 2.58 | 2.3 | 1.4 | 1.7 | 1.7 |
| Viscosity | 151 | 142 | 226 | 145 | 164 | 253 | 180 |
| (mPas) | | | | | | | |
| pH (neat | 4.65 | 4.76 | 4.65 | 5.1 | 5.1 | 5.0 | 5.2 |
| formulation) | | | | | | | |
| Content of | 504.28 | 506.07 | 502.28 | 500.6 | 506.8 | 497.7 | 496.80 |
| herbicide A | | | | | | | |
| (g/l) | | | | | | | |
| Content of | 5.73 | 5.65 | 5.57 | 6.34 | 6.34 | 6.18 | 5.67 |
| herbicide B* | | | | | | | |
| (g/l) | | | | | | | |

Measurements after storage for 8 weeks at 40 °C

| | | | | | | | |
|---|---|---|---|---|---|---|---|
| Visual | slight | slight | slight | traces | traces | traces | slight |
| appearance | serum | serum | serum | serum | serum | serum | serum |
| | on top | on top | on top | on top | on top | on top | on top |
| D₅₀ (μm) | 1.12 | 0.927 | 1.18 | 0.6 | 0.8 | 1.0 | 0.95 |
| D₉₀ (μm) | 2.56 | 1.93 | 1.91 | 1.5 | 1.5 | 1.8 | 1.55 |
| Viscosity | 135 | 149 | 239 | 108 | 103 | 184 | 182 |
| (mPas) | | | | | | | |
| pH (neat | 4.63 | 4.79 | 4.59 | 5.1 | 5.1 | 5.0 | 4.95 |
| formulation) | | | | | | | |
| Content of | 502.3 | — | 499.95 | — | — | — | 497.04 |
| herbicide A | | | | | | | |
| (g/l) | | | | | | | |
| Content of | 5.70 | — | 5.54 | — | — | — | 5.69 |
| herbicide B* | | | | | | | |
| (g/l) | | | | | | | |

*content of herbicide B determined as acid

As can be seen from Table 3, visual inspection of the samples showed no phase separation at all or only a small amount of serum formation which could be easily re-emulsified if necessary. No significant increase in particle size (D₅₀ and D₉₀ values) could be observed upon storage, or the D₅₀ and D₉₀ values were still in an acceptable range. The viscosity, pH and the active ingredient content of herbicides A and B also remained within an acceptable range under the above storage conditions.

The overall results of Table 3 demonstrate that the oil-in-water emulsion formulations of the present invention possess good physicochemical stability after 2 weeks of storage at 54 °C and 8 weeks of storage at 40 °C.

### IV. Herbicidal Activity and Phytotoxicity

The herbicidal activity and phytotoxicity on cultivated plants of the formulation B according to Table 2 were tested in the following field trials:

Trials were conducted under field conditions in a randomized bloc design with 3-4 replication in different European regions. Crop cultivation including soil preparation, sowing, fertilization and maintaining plant protection measures were implemented according to local or regional practices.

The formulation B was diluted with 150-300 l/ha water to provide a diluted formulation before application.

For the pre-emergence treatment, the diluted formulation as described above was applied either directly after sowing or until shortly before emergence of the crop by means of finely distributing nozzles.

For the post-emergence treatment, winter oilseed rape was grown to a growth stage up to BBCH 16, depending on the plant habit, and only then treated with the diluted formulation as described above. Growth stages of weeds present at the time of post-emergence application ranged from BBCH 09-16 (emergence till 6 leaf-stage). The test period extended till the onset of the vegetation period in the spring following the application in autumn.

The application rates of the formulation B were 0.6 and 1.0 l/ha for both the pre-emergence and the post-emergence treatment.

The response of the crop and the weeds to the individual treatments was evaluated.

Evaluation was carried out using a scale from 0 to 100. 100 means no emergence of the plants, or complete destruction of at least the above-ground parts, and 0 means no damage or normal course of growth. A good herbicidal activity is given at values of at least 70, and very good herbicidal activity is given at values of at least 85. Phytotoxicity means herbicidal activity on cultivated plants.

The tested weeds present in the trial area sown with winter oilseed rape (BRSNWN) were of natural occurrence. Efficacy and phytotoxicity was evaluated about 6-14 weeks following the application in autumn.

Test plants in pre-emergence application were Anthemis arvensis (ANTAR), Apera spica-venti (APESV), Capsella bursa-pastoris (CAPBP), Centaurea cyanus (CENCY), Chenopodium album (CHEAL), Geranium rotundifolium (GERRT), Lamium amplexicaule (LAMAM), Lamium purpureum (LAMPU), Matricaria chamomilla (MATCH), Tripleurospermum inodorum (MATIN), Papaver rhoeas (PAPRH), Stellaria media (STEME), Veronica hederaefolia (VERHE), Veronica persica (VERPE) and Viola arvensis (VIOAR) on the undesired vegetation side, and on the other side, for phytotoxicity tests, winter oilseed rape (BRSNW).

For the post-emergence application, test plants were Anthemis arvensis (ANTAR), Apera spicaventi (APESV), Capsella bursa-pastoris (CAPBP), Cenctaurea cyanus (CENCY), Chenopodium album (CHEAL), Geranium dissectum (GERDI), Geranium rotundifolium (GERRT), Matricaria chamomilla (MATCH), Tripleurospermum inodorum (MATIN), Papaver rhoeas (PAPRH), Stellaria media (STEME), Veronica hederaefolia (VERHE), Veronica persica (VERPE) and Viola arvenis (VIOAR) on the undesired vegetation side, and on the other side, for phytotoxicity tests, winter oilseed rape (BRSNWN).

The results are compiled in Tables 4 and 5 below.

TABLE 4
Herbicidal activity and phytotoxicity of Formulation Example
B applied pre-emergence in winter oilseed rape (BRSNW)
at application rates of 0.6 l/ha and 1.0 l/ha

Phytotoxicity/herbicidal activity

| Trial No. | Plant species | 0.6 l/ha | 1.0 l/ha |
|---|---|---|---|
| 1 | BRSNW | 0 | 0 |
| | CAPBP | 82 | 92 |
| 2 | BRSNW | 0 | 0 |
| | STEME | 100 | 100 |
| 3 | BRSNW | 0 | 0 |
| | CAPBP | 78 | 95 |
| | VERHE | 65 | 78 |
| | ANTAR | 88 | 100 |
| | VERPE | 47 | 92 |
| 4 | BRSNW | 3 | 18 |
| | CAPBP | 83 | 99 |
| | MATCH | 94 | 97 |
| | STEME | 97 | 99 |
| | PAPRH | 80 | 97 |
| | GERRT | 83 | 93 |
| 5 | BRSNW | 0 | 0 |
| | CHEAL | 100 | 100 |
| 6 | BRSNW | 0 | 0 |
| | LAMAM | 100 | 100 |
| 7 | BRSNW | 0 | 0 |
| | CAPBP | 100 | 100 |
| | MATIN | 100 | 100 |
| | VIOAR | 83 | 92 |
| | CENCY | 95 | 100 |
| 8 | BRSNW | 0 | 0 |
| | CAPBP | 100 | 100 |
| | VIOAR | 85 | 93 |
| | STEME | 100 | 100 |
| | PAPRH | 90 | 100 |
| 9 | BRSNW | 0 | 0 |
| | PAPRH | 88 | 93 |
| | APESV | 89 | 94 |
| 10 | BRSNW | 0 | 0 |
| | CAPBP | 96 | 100 |
| | CHEAL | 100 | 100 |
| | LAMPU | 93 | 96 |
| | MATIN | 96 | 100 |
| | VIOAR | 81 | 91 |
| | STEME | 92 | 100 |

TABLE 5
Herbicidal activity and phytotoxicity of Formulation Example
B applied post-emergence in winter oilseed rape (BRSNW)
at application rates of 0.6 l/ha and 1.0 l/ha

Phytotoxicity/herbicidal activity

| Trial No. | Plant species | 0.6 l/ha | 1.0 l/ha |
|---|---|---|---|
| 1 | BRSNW | 0 | 0 |
| | GERRT | 68 | 94 |
| 2 | BRSNW | 0 | 0 |
| | CAPBP | 72 | 87 |
| | STEME | 100 | 100 |
| 3 | BRSNW | 0 | 0 |
| | CAPBP | 73 | 92 |
| | VERHE | 62 | 83 |
| | GERDI | 63 | 83 |
| | ANTAR | 77 | 100 |
| | VERPE | 78 | 88 |
| 4 | BRSNW | 0 | 0 |
| | MATCH | 98 | 99 |
| | STEME | 89 | 91 |
| | PAPRH | 70 | 99 |
| | GERRT | 87 | 97 |
| 5 | BRSNW | 0 | 0 |
| | CHEAL | 99 | 100 |
| 6 | BRSNW | 0 | 0 |
| | CAPBP | 100 | 100 |
| | MATIN | 100 | 100 |
| | VIOAR | 85 | 90 |
| | CENCY | 88 | 87 |
| 7 | BRSNW | 0 | 0 |
| | CAPBP | 99 | 100 |
| | VIOAR | 82 | 87 |
| | STEME | 92 | 93 |
| | PAPRH | 83 | 85 |
| 8 | BRSNW | 0 | 0 |
| | PAPRH | 99 | 100 |
| | APESV | 96 | 99 |

The results of the field trials depicted in Tables 4 and 5 demonstrate that the oil-in-water emulsion formulation according to this invention provides an excellent herbicidal activity on various weeds, while at the same exhibiting no or no significant phytotoxicity on crops, in particular oilseed rape. Further, the oil-in-water emulsion formulation of this invention can be used for both pre- and post-emergence weed control, especially in oilseed rape, thus allowing a flexible application timing.

### V. Comparative Example 1

Formulations H and I (both according to the invention) were prepared by the procedure described in Section II above. For comparative purposes, Formulation J (not of the invention) was prepared by the same procedure and using the same components and in the same concentrations as Formulations H and I except that the solvent S2a (used in formulation H) or S2b (used in formulation C) was replaced by the non-polar solvent S1.

The individual components and their concentrations (in g/l) of Formulations H (invention), I (invention) and J (comparison, not of the invention) are summarized in Table 6 below.

TABLE 6
Components and concentrations of Formulations H (invention),
I (invention) and J (comparison, not of the invention)

| | H | | I | | J | |
|---|---|---|---|---|---|---|
| Component* | (invention) | | (invention) | | (comparison) | |
| Dimethenamid-P (Herbicide A) | 500 | g/l | 500 | g/l | 500 | g/l |
| Aminopyralid-potassium (Herbicide B)** | 6 | g/l | 6 | g/l | 6 | g/l |
| Aromatic hydrocarbon mixture, initial boiling | 50 | g/l | 50 | g/l | 100 | g/l |
| point at 220 °C, final boiling point at 305 °C, | | | | | | |
| maximum naphthalene content of 0.9 wt. % | | | | | | |
| (Non-polar solvent S1) | | | | | | |
| 2,2,4-trimethyl-1,3-pentanediol monoisobutyrate | 50 | g/l | — | | — | |
| (Solvent S2a) | | | | | | |
| N,N-dimethyllactamide (Solvent S2b) | — | | 50 | g/l | — | |
| Polyalkylene glycol butyl ether, the polyalkylene | 17.5 | g/l | 17.5 | g/l | 17.5 | g/l |
| glycol unit being an ethylene oxide/propylene | | | | | | |
| oxide block copolymer, OH number 17- | | | | | | |
| 26 mg KOH/g, HLB value 14, molar weight | | | | | | |
| 5200 g/mol (Nonionic surfactant C.1) | | | | | | |
| Ethoxylated isotridecyl alcohol, degree of | 17.5 | g/l | 17.5 | g/l | 17.5 | g/l |
| ethoxylation approximately 6 (Nonionic | | | | | | |
| surfactant C.2) | | | | | | |
| Tristyrylphenol (ethylene oxide)₁₆ sulfate | 10 | g/l | 10 | g/l | 10 | g/l |
| ammonium salt (Anionic surfactant C.3) | | | | | | |
| Poly(vinylpyrrolidone co-vinyl acetate), having | 20 | g/l | 20 | g/l | 20 | g/l |
| a ratio of vinylpyrrolidone (VP) to vinyl acetate | | | | | | |
| (VA) in a weight ratio of 60:40 (Stabilizer D.1) | | | | | | |
| Microcrystalline cellulose powder with an average | 5 | g/l | 5 | g/l | 5 | g/l |
| particle size of 20 μm (Stabilizer D.2) | | | | | | |
| Glycerin (antifreeze agent) (Auxiliary F.1) | 125 | g/l | 125 | g/l | 125 | g/l |
| Polydimethylsiloxane-based antifoams (Auxiliary F.2) | 0.5 | g/l | 0.5 | g/l | 0.5 | g/l |
| Preservatives based on 5-chloro-2-methyl-4- | 2 | g/l | 2 | g/l | 2 | g/l |
| isothiazolin-3-one and/or 2-methyl-4-isothiazolin- | | | | | | |
| 3-one and/or 1,2-benzisothiazol-3(2H)- | | | | | | |
| one (Auxiliary F.3) | | | | | | |

| | | | |
|---|---|---|---|
| Water | Ad 1 l | Ad 1 l | Ad 1 l |

*all components listed in Table 6 are commercially available
**concentration of herbicide B calculated on an acid equivalent basis

The herbicidal activity and phytotoxicity on cultivated plants of the Formulations H, I and J according to Table 6 were tested in the following field trials:

Trials were conducted under field conditions in a randomized bloc design with 3 replication in Europe. Crop cultivation including soil preparation, sowing, fertilization and maintaining plant protection measures were implemented according to local practices.

Formulations H, I and J were each diluted with 200 l/ha water to provide a diluted composition before application.

For the post-emergence treatment, spring oilseed rape (BRSNS) was grown to a growth stage up to BBCH 15, depending on the plant habit, and only then treated with the diluted formulation as described above. Weeds present at the time of post-emergence application corresponded with the growth stages of the crop. The test period last for about 54 days till flowering of the crop (BBCH 61-65).

The application rates of each of the Formulations H, I and J were 0.6 and 1.0 l/ha for the post-emergence treatment.

The response of the crop and the weeds to the individual treatments was evaluated.

Evaluation was carried out using a scale from 0 to 100. 100 means no emergence of the plants, or complete destruction of at least the above-ground parts, and 0 means no damage or normal course of growth. A good herbicidal activity is given at values of at least 70, and very good herbicidal activity is given at values of at least 85. Phytotoxicity means herbicidal activity on cultivated plants.

The tested weeds present in the trial area sown with spring oilseed rape (BRSNS) were of natural occurrence. Efficacy and phytotoxicity were evaluated about 6-8 weeks following the application.

For the post-emergence application, test plants were Anthemis arvensis (ANTAR), Galium aparine (GALAP), Geranium pusillum (GERPU), Tripleurospermum inodorum (MATIN), Papaver rhoeas (PAPRH), Fallopia convolvulus (POLCO) and Sonchus oleraceus (SONOL) on the undesired vegetation side, and on the other side, for phytotoxicity tests, spring oilseed rape (BRSNS).

The results are compiled in Tables 7 and 8 below.

TABLE 7
Comparison of the herbicidal activity and phytotoxicity of Formulations H (invention),
I (invention) and J (comparative, not of the invention) applied post-emergence at
an application rate of 0.6 l/ha and evaluated at 54 DAT (days after treatment)

| | | Formulation H | Formulation I | Formulation J |
|---|---|---|---|---|
| | | (invention, with non- | (invention, with non- | (comparative, with |
| Trial | Plant | polar solvent S1 + | polar solvent S1 + | only non-polar |
| No. | species | solvent S2a) | solvent S2b) | solvent S1) |
| 1 | BRSNS | 0 | 0 | 0 |
| | ANTAR | 72 | 90 | 70 |
| | GALAP | 60 | 60 | 50 |
| | GERPU | 60 | 70 | 60 |
| | PAPRH | 80 | 91 | 80 |
| | POLCO | 82 | 77 | 70 |
| 2 | BRSNS | 0 | 0 | 0 |
| | GERPU | 58 | 60 | 0 |
| | MATIN | 57 | 70 | 37 |
| | PAPRH | 67 | 60 | 55 |

TABLE 8
Comparison of the herbicidal activity and phytotoxicity of Formulations H (invention),
I (invention) and J (comparative, not of the invention) applied post-emergence at
an application rate of 1.0 l/ha and evaluated at 54 DAT (days after treatment)

| | | Formulation H | Formulation I | Formulation J |
|---|---|---|---|---|
| | | (invention, with non- | (invention, with non- | (comparative, with |
| Trial | Plant | polar solvent S1 + | polar solvent S1 + | only non-polar |
| No. | species | solvent S2a) | solvent S2b) | solvent S1) |
| Trial 1 | BRSNS | 0 | 0 | 0 |
| | ANTAR | 91 | 95 | 83 |
| | GALAP | 60 | 70 | 43 |
| | GERPU | 60 | 73 | 57 |
| | POLCO | 88 | 87 | 57 |
| Trial 2 | BRSNS | 0 | 0 | 0 |
| | GERPU | 65 | 70 | 0 |
| | MATIN | 77 | 75 | 50 |
| | PAPRH | 77 | 78 | 67 |
| | SONOL | 50 | 77 | 37 |

The results of the field trials depicted in Tables 7 and 8 demonstrate that the oil-in-water emulsion formulation according to this invention comprising a solvent mixture of a non-polar solvent S1 and a solvent S2 having a higher polarity than the non-polar solvent S1 such as, for example, 2,2,4-trimethyl-1,3-pentanediol monoisobutyrate (solvent S2a) and N,N-dimethyllactamide (solvent S2b) provides a significantly better post-emergence weed control compared with a formulation comprising only said non-polar solvent S1 (except for two treatments of Formulation H on GERPU and PAPRH at 0.6 l/ha, trial No. 1, resulting in the same efficacy), while not compromising on the crop safety. In addition to the foregoing results in Section IV, these findings confirm that the oil-in-water emulsion formulation of this invention provides a post-emergence weed control option, especially in oilseed rape, thus allowing a flexible application timing from pre- to post-emergence treatments.

### VI. Comparative Example 2

It was attempted to prepare an emulsion according to the procedure described in US 2011/0092367 A1 (see page 11, paragraphs [0141] and [0142]) by using the active ingredients present in the oil-in-water emulsion formulation of this invention, i.e., Dimethenamid-P as the herbicide A and Aminopyralid potassium salt as the herbicide B. The components and their content (in weight-% based on the total weight of the formulation) are listed in Table 9 below.

TABLE 9
Components and their content (in weight-%) of an emulsion analogous
to US 2011/0092367 A1 by using a mixture of Dimethenamid-P
and Aminopyralid potassium salt as active compounds

| | Content |
|---|---|
| Component | (weight-%) |
| Active compound 1 = | 24.65 |
| Dimethenamid-P (Herbicide A) | |
| Active compound 2 = | 0.35 |
| Aminopyralid-potassium (Herbicide B) | |
| organic solvent (e.g., alkylaromatics) = | 35 |
| Solvesso 200 ND | |
| Calcium dodecylbenzene sulfonate | 5 |
| (Wettol EM 1) | |
| Castor oil ethoxylate | 5 |
| (Wettol EM 31) | |
| Water (ad. 100%) | 30 |

As a preliminary step, solubility tests were performed to determine the ability of Aminopyralid potassium salt used as herbicide B to dissolve in the organic solvent Solvesso 200ND and the oil phase of the emulsion disclosed in US 2011/0092367 A1, page 11, paragraphs [0141] and [0142].

### VI.1 Solubility of Aminopyralid Potassium Salt in the Organic Solvent (Solvesso 200ND)

The solubility was measured in a test tube at room temperature. 0.10 g of Aminopyralid potassium salt was placed in the test tube. First, 1 g of the organic solvent (Solvesso 200 ND) was added. The amount of the organic solvent (Solvesso 200 ND) was then increased in several steps to 10 g. After each of these steps, the resulting mixture was agitated with a magnetic stirrer and a poor solubility was observed visually. The solubility of Aminopyralid Potassium salt in Solvesso 200ND was visually determined to be less than 1%.

### VI.2 Solubility of Aminopyralid Potassium Salt in the Oil Phase of the Emulsion of US 2011/0092367 A1

The organic solvent (Solvesso 200 ND), calcium dodecylbenzene sulfonate (Wettol EM 1) and castor oil ethoxylate (Wettol EM 31) were mixed in the amounts given in Table 9. Aminopyralid potassium salt was then added to this mixture in the amount given in Table 9. After mixing, it was not soluble in said mixture. After further adding dimethenamid-P in the amount given in Table 9, solubility of the Aminopyralid potassium salt could not be increased. In summary, Aminopyralid potassium salt (herbicide B) was not soluble in the oil phase of the emulsion as disclosed in US 2011/0092367 A1 (see page 11, paragraphs [0141] and [0142]).

Thus, it was not possible to prepare a stable emulsion under the conditions disclosed in US 2011/0092367 A1 by using a mixture of Dimethenamid-P (herbicide A) and Aminopyralid potassium salt (herbicide B) as active compounds.

1. An oil-in-water emulsion formulation comprising
a) a discontinuous oil phase comprising a herbicide A selected from chloroacetamide herbicides and a solvent mixture S comprising a non-polar solvent S1 and a solvent S2 having a higher polarity than the non-polar solvent S1,
b) a continuous aqueous phase comprising a herbicide B which is a water-soluble salt of a pyridinecarboxylic acid herbicide and water, and
c) a surfactant mixture C comprising at least two nonionic surfactants C.1 and C.2 and at least one anionic surfactant C.3.

2. The formulation according to claim 1 wherein the polarity of the solvent S2 is measured by the Hansen solubility parameters, a sum of the Hansen parameter for polarity (δₚ) and the Hansen parameter for hydrogen bonding (bn) being higher than the sum of the corresponding Hansen parameters of the non-polar solvent S1.

3. The formulation according to claim 2, wherein the sum of the Hansen parameter for polarity (δₚ) and the Hansen parameter for hydrogen bonding (bn) of the solvent S2 is in the range from 12 to 40 MPa^{0.5}, preferably in the range from 12 to 35 MPa^{0.5} and more preferably in the range from 15 to 30 MPa^{0.5}, and the sum of the corresponding Hansen parameters of the non-polar solvent S1 is in the range from 0 to 10 MPa^{0.5}, preferably in the range from 0 to 8 MPa^{0.5}.

4. The formulation according to any one of claims 1 to 3 wherein the solvent mixture S has a solubility in water of 0.1% by weight or less at 21 °C, based on the amount of water.

5. The formulation according to any one of claims 1 to 4 wherein the solvent mixture S has a flash point of at least 70 °C, preferably at least 100 °C.

6. The formulation according to any one of claims 1 to 5 wherein the non-polar solvent S1 is selected from aromatic hydrocarbons and the solvent S2 is selected from 2-ethylhexanol, 2,2,4-trimethyl-1,3-pentanediol monoisobutyrate, N,N-dimethyl(C₂-C₂₀)hydroxyalkylamides and any combination thereof

7. The formulation according to any one of claims 1 to 6 wherein the non-polar solvent S1 is an aromatic hydrocarbon mixture with an initial boiling point of at least 160 °C, preferably at least 180 °C.

8. The formulation according to any one of claims 1 to 7 wherein the solvent S2 is selected from 2,2,4-trimethyl-1,3-pentanediol monoisobutyrate, N,N-dimethyl(C₂-C₂₀)hydroxyalkylamides or a combination thereof, preferably from 2,2,4-trimethyl-1,3-pentanediol monoisobutyrate, N,N-dimethyllactamide or a combination thereof.

9. The formulation according to any one of claims 1 to 8 wherein the nonionic surfactant C.1 has a HLB ranging from 8 to 12, preferably 10 to 12, and the nonionic surfactant C.2 has a HLB ranging from 12 to 18.

10. The formulation according to any one of claims 1 to 9 wherein the nonionic surfactant C.1 is selected from polyalkoxylated alkyl ethers, the nonionic surfactant C.2 is selected from C₁₀-C₁₄-alcohol polyglycol ethers and the anionic surfactant C.3 is selected from polyarylphenol polyalkoxy ether sulfates.

11. The formulation according to claim 10 wherein the nonionic surfactant C.1 is a polyalkoxylated butyl ether, the nonionic surfactant C.2 is an iso-tridecyl alcohol polyglycol ether and the anionic surfactant C.3 is a tristyrylphenol ethoxylate sulfate ammonium salt.

12. The formulation according to any one of claims 1 to 11, comprising a stabilizer D selected from polyvinylpyrrolidone, vinylpyrrolidone-vinyl acetate copolymers, microcrystalline cellulose, cellulose derivatives, alginates, and any combination thereof.

13. The formulation according to any one of claims 1 to 12 wherein the herbicide A is dimethenamid-P.

14. The formulation according to any one of claims 1 to 13 wherein the herbicide B is a water-soluble salt of aminopyralid.

15. The formulation according to claim 14 wherein the water-soluble salt of aminopyralid is selected from aminopyralid-sodium, aminopyralid-potassium, aminopyralid-choline salt, aminopyralid-ammonium, aminopyralid-methylammonium, aminopyralid-dimethylammonium, aminopyralid-isopropylammonium, aminopyralid-hydroxy ethylammonium, aminopyralid-di(hydroxyethyl)ammonium, aminopyralid-tri(hydroxyethyl)ammonium, aminopyralid-hydroxypropylammonium, aminopyralid-di(hydroxypropyl)ammonium, aminopyralid-tri(hydroxypropyl)ammonium, aminopyralid-triisopropanolammonium, aminopyralid-diglycolamine salt, aminopyralid-olamine salt, aminopyralid-dimethylamine salt, aminopyralid-monoethanolamine salt, aminopyralid-triisopropanolamine salt, and any combination thereof.

16. The formulation according to claim 14 or 15 wherein the water-soluble salt of aminopyralid is aminopyralid-potassium.

17. The formulation according to any one of claims 1 to 16 comprising an adjuvant E selected from ethylene oxide/propylene oxide block copolymers, alcohol alkoxylates, polyoxyalkylene sorbitan fatty acid esters, and any combination thereof, preferably from polyoxyalkylene sorbitan fatty acid esters and more preferably from polyoxyethylene sorbitan fatty acid esters.

18. The formulation according to claim 17 wherein the adjuvant E is polyoxyethylene sorbitan monolaurate.

19. The formulation according to any one of claims 1 to 18, comprising one or more auxiliaries F selected from antifreeze agents, anti-foaming agents, preservatives, colorants, UV absorbers, and any combination thereof.

20. The formulation according to any one of claims 1 to 19 wherein the oil phase droplets in the emulsion have an average particle size D₅₀ of from 0.2 μm to 1.5 μm, preferably 0.4 μm to 1.0 μm.

21. A process for preparing an oil-in-water emulsion formulation as defined in any one of claims 1 to 20 comprising the steps of
a) mixing water, the pyridinecarboxylic acid herbicide in its acid form and a base to form an aqueous solution of the water-soluble salt of the pyridinecarboxylic acid herbicide (herbicide B),
b) adding the stabilizer D and optionally hydrophilic auxiliaries F to the aqueous solution obtained in step a) to form an aqueous phase,
c) preparing an oil phase comprising the herbicide A, the solvent mixture S, the surfactant mixture C and optionally lipophilic auxiliaries F, and
d) mixing the oil phase obtained in step c) with the aqueous phase obtained in step b) under stirring and subsequent high shear homogenization to obtain the oil-in-water emulsion formulation.

22. The process according to claim 21 optionally comprising an additional step e) of adding the adjuvant E to the oil-in-water emulsion formulation obtained in step d) under stirring and subsequent high shear homogenization.

23. A method for controlling undesirable vegetation comprising applying an oil-in-water emulsion formulation as defined in any one of claims 1 to 20 to the vegetation or the locus thereof.

24. Use of an oil-in-water emulsion formulation as defined in any one of claims 1 to 20 for controlling undesirable vegetation.
